(19) United States
(12) Patent Application Publication
(10) Pub. No.: US 2023/0359696 A1
(43) Pub. Date: Nov. 9, 2023

(54) STATISTICAL DISTANCE MATRIX CALCULATION METHOD, AND STATISTICAL DISTANCE MATRIX VISUALIZATION METHOD, DEVICE, AND PROGRAM

(71) Applicant: LU Xin, Iwate (JP)

(72) Inventor: LU Xin, Iwate (JP)

(21) Appl. No.: 18/246,265

(22) PCT Filed: Sep. 21, 2021
(86) PCT No.: PCT/JP2021/034509

§ 371 Date: Mar. 22, 2023

(30) Foreign Application Priority Data
Sep. 23, 2020 (JP) 2020-158384

(51) Int. Cl. G06F 17/18; G06F 7/50

(52) U.S. Cl. CPC G06F 17/18; G06F 7/50

(57) ABSTRACT

The purpose of the present invention is to convert statistical distances into a statistical distance matrix in order to refine the distances. A processing unit calculates first and second mean vectors μμ1 and μμ2, and first and second covariance matrices ΣΣ1 and ΣΣ2 as targets for comparison from first and second vector data aa and bb, or from first and second matrices or sets AA and BB to find a statistical distance matrix DD as a de-trace form of a statistical distance D defined by them. The processing unit accumulates local distances related to the statistical distance matrix DD to find a distance accumulation vector φφ and matrix the distance accumulation vector φφ into a distance accumulation matrix ϕϕ. The processing unit stores, in a storage unit, or displays, on a display unit, or outputs, through an output unit, the distance accumulation matrix ϕϕ or an image by the distance accumulation matrix ϕϕ. The processing unit can execute clustering processing on the statistical distance matrix DD to further assign cluster labels or element labels to the distance accumulation matrix ϕϕ.

### TECHNICAL FIELD

The present invention relates to a statistical distance matrix calculation method, a statistical distance matrix visualization method, a device, and a program, and particularly relates to a statistical distance matrix calculation method, a statistical distance matrix visualization method, a device, and a program using refinement, representation, and clustering of a statistical distance matrix.

### BACKGROUND ART

Machine learning is classified into three types, namely, supervised learning, unsupervised learning, and reinforcement learning. There are cases of classification, regression, clustering, dimensionality reduction, anomaly detection, and the like for specific purposes, and there are many algorithms such as a support vector machine, K-means clustering, and a decision tree as methods of finding solutions. However, a distance function related to observation features must be designed and optimized no matter what algorithm is used. For example, a support vector machine in classification needs to measure a feature distance between two observation categories using the most efficient kernel function. The K-means clustering aims to divide observations into clusters in order to minimize the within-cluster sum of squares metric of the observation features in Euclidean or Mahalanobis space.

The statistical distance is defined as a distance between two probability distributions using a set of samples (observations) independently generated according to the two probability distributions. Since the statistical distance has mathematical properties that a general distance does not have, the measurement thereof is not only more effective and appropriate for machine learning, but also more robust to small outliers. Some of important statistical distances that have been used until now, namely, Mahalanobis Distance [9], Bhattacharya Distance (Mahalanobis Distance) [1], Hellinger Distance [4], Kullback-Leibler Divergence [7], Chernoff Distance [2], and the like are widely applied in the field of artificial intelligence including image segmentation, texture segmentation, color and texture matching, feature extraction, speech recognition, and action recognition.

As conventional technology, for example, the following documents are mentioned.

In Patent Document 1, “a machine learning program, a machine learning method, and a machine learning device capable of improving determination accuracy of learning equipment containing a convolution process” (Abstract) are disclosed.

In Patent Document 2, “a determination device and a determination method capable of improving image retrieval accuracy by utilizing association among three or more images” (Abstract) are disclosed.

In Patent Document 3, image retrieval using a distance measurement method in such a manner that “a Mahalanobis distance measuring unit is used to identify a query image from among plural images in a database” (Abstract) is disclosed.

In Patent Document 4, systems and methods for quantum processing of data, in which “a quantum processor is programmed to achieve Hierarchal Deep Learning (referred to as HDL) over one or more data sets in order to achieve unsupervised or semi-supervised learning of features” (Abstract) are disclosed.

### CITATION LIST

### Patent Documents

Patent Document 1: Japanese Unexamined Patent Application Publication No. 2019-185483
Patent Document 2: Japanese Unexamined Patent Application Publication No. 2019-185483
Patent Document 3: U.S. Pat. No. 6,681,060
Patent Document 4: U.S. Pat. No. 10,318,881

### SUMMARY OF INVENTION

### Technical Problem

However, since the conventional statistical distances that have been used until now, such as Mahalanobis Distance [9], Bhattacharya distance (Mahalanobis Distance) [1], Hellinger Distance [4], Kullback-Leibler Divergence [7], and Chernoff Distance [2], only provide scalar output to represent a global distance between two observation sets regardless of the size of observation feature elements, there is an obvious problem that the local distances between all feature elements within the observations are assumed not to be able to be elaborated. Therefore, a method of converting the scalar-valued statistical distances into distance matrices to refine the distances is very important.

On the other hand, the concept of a distance matrix has been introduced in graph theory [3]. For example, a distance matrix in a directed graph is defined by a weighted adjacent matrix. When each edge is assigned a weight, the distance between two vertices can be measured as the minimum sum of the weights of the shortest paths connecting the two vertices. Since the paths are oriented, the distance matrix is asymmetric and not a mathematically rigorous metric having symmetry. When the number of respective vertex samples is sufficient enough, a correlation matrix or a cross-correlation matrix is used to identify the weights of adjacent matrix elements and quantify the distance matrix. However, due to information loss from the assumption that all the data follow a probability space, the correlation matrix does not meet some of high machine-learning requirements.

Further, unlike the invention in this specification, Patent Documents 1 to 4 described above neither disclose nor suggest the process of converting a statistical distance into a matrix and/or a method related to element clustering.

In order to solve the above-described problems, the conventional statistical distances are transformed into matrix forms, for example, through a simple de-trace operation, and statistical distance matrices having unprecedented high performance are proposed in the present invention. Experiments on the image dataset CIFAR-10 [6], which is most famous in the field of machine learning, were conducted, and it was confirmed that the statistical distance matrices were effective even when they were complex.

In view of the above points, it is an object of the present invention to convert scalar-valued statistical distances into statistical distance matrices in order to refine the distances.

### Solution to Problem

According to a first solving means of the present invention, there is provided a statistical distance matrix calculation method including:
causing a processing unit to input, from an input unit or any other device or a storage unit, first vector data aa and second vector data bb as targets for comparison, or causing the processing unit to input, from the input unit or any other device or the storage unit, a first matrix or image or aggregate data AA and a second matrix or image or aggregate data BB as targets for comparison, and vectorize the first matrix or image or aggregate data AA and the second matrix or image or aggregate data BB into the first vector data aa and the second vector data bb;
causing the processing unit to calculate, from the first vector data aa and the second vector data bb, a first mean vector μμ1 and a second mean vector μμ2, and a first covariance matrix ΣΣ1 and a second covariance matrix ΣΣ2, respectively;
causing the processing unit to find a statistical distance matrix DD (here, D=trDD) as a de-trace form of a statistical distance D defined by the first mean vector μμ1, the second mean vector μμ2, the first covariance matrix ΣΣ1, and the second covariance matrix ΣΣ2; and
causing the processing unit to store the statistical distance matrix DD in the storage unit, or display the statistical distance matrix DD on a display unit, or output the statistical distance matrix DD through an output unit.

According to a second solving means of the present invention, there is provided a statistical distance matrix visualization method including:
causing a processing unit to input, from an input unit or any other device or a storage unit, first vector data aa and second vector data bb as targets for comparison, or causing the processing unit to input, from the input unit or any other device or the storage unit, a first matrix or image or aggregate data AA and a second matrix or image or aggregate data BB as targets for comparison, and vectorize the first matrix or image or aggregate data AA and the second matrix or image or aggregate data BB into the first vector data aa and the second vector data bb;
causing the processing unit to calculate, from the first vector data aa and the second vector data bb, a first mean vector μμ1 and a second mean vector μμ2, and a first covariance matrix ΣΣ1 and a second covariance matrix ΣΣ2, respectively;
causing the processing unit to find a statistical distance matrix DD (here, D=trDD) as a de-trace form of a statistical distance D defined by the first mean vector μμ1, the second mean vector μμ2, the first covariance matrix ΣΣ1, and the second covariance matrix ΣΣ2;
causing the processing unit to accumulate row and column distance elements including diagonal elements for respective diagonal elements of the statistical distance matrix DD to find a distance accumulation vector φφ;
causing the processing unit to matrix the distance accumulation vector φφ into a distance accumulation matrix ϕϕ; and
causing the processing unit to store the distance accumulation matrix ϕϕ or an image by the distance accumulation matrix ϕϕ in the storage unit, or display the distance accumulation matrix ϕϕ or the image by the distance accumulation matrix ϕϕ on a display unit, or output the distance accumulation matrix ϕϕ or the image by the distance accumulation matrix ϕϕ through an output unit.

According to a third solving means of the present invention, there is provided a statistical distance matrix visualization method including:
causing a processing unit to input, from an input unit or any other device or a storage unit, first vector data aa and second vector data bb as targets for comparison, or causing the processing unit to input, from the input unit or any other device or the storage unit, a first matrix or image or aggregate data AA and a second matrix or image or aggregate data BB as targets for comparison, and vectorize the first matrix or image or aggregate data AA and the second matrix or image or aggregate data BB into the first vector data aa and the second vector data bb;
causing the processing unit to calculate, from the first vector data aa and the second vector data bb, a first mean vector μμ1 and a second mean vector μμ2, and a first covariance matrix ΣΣ1 and a second covariance matrix ΣΣ2, respectively;
causing the processing unit to find a statistical distance matrix DD (here, D=trDD) as a de-trace form of a statistical distance D defined by the first mean vector μμ1, the second mean vector μμ2, the first covariance matrix ΣΣ1, and the second covariance matrix ΣΣ2;
causing the processing unit to execute clustering processing on the statistical distance matrix DD in order to find a cluster label vector or set in which a cluster label for a number or an ID corresponding to each row or a number or an ID corresponding to each column is set as an element;
causing the processing unit to matrix the cluster label vector or set into a cluster label matrix; and
causing the processing unit to store the cluster label matrix or an image by the cluster label matrix in the storage unit, or display the cluster label matrix or the image by the cluster label matrix on a display unit, or output the cluster label matrix or the image by the cluster label matrix through an output unit.

According to a fourth solving means of the present invention, there is provided a statistical distance matrix visualization device including a processing unit, wherein
the processing unit inputs, from an input unit or any other device or a storage unit, first vector data aa and second vector data bb as targets for comparison, or the processing unit inputs, from the input unit or any other device or the storage unit, a first matrix or image or aggregate data AA and a second matrix or image or aggregate data BB as targets for comparison, and vectorizes the first matrix or image or aggregate data AA and the second matrix or image or aggregate data BB into the first vector data aa and the second vector data bb,
the processing unit calculates, from the first vector data aa and the second vector data bb, a first mean vector μμ1 and a second mean vector μμ2, and a first covariance matrix ΣΣ1 and a second covariance matrix ΣΣ2, respectively,
the processing unit finds a statistical distance matrix DD (here, D=trDD) as a de-trace form of a statistical distance D defined by the first mean vector μμ1, the second mean vector μμ2, the first covariance matrix ΣΣ1, and the second covariance matrix ΣΣ2,
the processing unit accumulates row and column distance elements including diagonal elements for respective diagonal elements of the statistical distance matrix DD to find a distance accumulation vector φφ,
the processing unit matrixes the distance accumulation vector φφ into a distance accumulation matrix ϕϕ, and
the processing unit stores the distance accumulation matrix ϕϕ or an image by the distance accumulation matrix ϕϕ in the storage unit, or displays the distance accumulation matrix ϕϕ or the image by the distance accumulation matrix ϕϕ on a display unit, or outputs the distance accumulation matrix ϕϕ or the image by the distance accumulation matrix ϕϕ through an output unit.

According to a fifth solving means of the present invention, there is provided a statistical distance matrix visualization program causing a computer to execute:
a step of causing a processing unit to input, from an input unit or any other device or a storage unit, first vector data aa and second vector data bb as targets for comparison, or causing the processing unit to input, from the input unit or any other device or the storage unit, a first matrix or image or aggregate data AA and a second matrix or image or aggregate data BB as targets for comparison, and vectorize the first matrix or image or aggregate data AA and the second matrix or image or aggregate data BB into the first vector data aa and the second vector data bb;
a step of causing the processing unit to calculate, from the first vector data aa and the second vector data bb, a first mean vector μμ1 and a second mean vector μμ2, and a first covariance matrix ΣΣ1 and a second covariance matrix ΣΣ2, respectively;
a step of causing the processing unit to find a statistical distance matrix DD (here, D=trDD) as a de-trace form of a statistical distance D defined by the first mean vector μμ1, the second mean vector μμ2, the first covariance matrix ΣΣ1, and the second covariance matrix ΣΣ2;
a step of causing the processing unit to accumulate row and column distance elements including diagonal elements for respective diagonal elements of the statistical distance matrix DD to find a distance accumulation vector φφ;
a step of causing the processing unit to matrix the distance accumulation vector φφ into a distance accumulation matrix ϕϕ; and
a step of causing the processing unit to store the distance accumulation matrix ϕϕ or an image by the distance accumulation matrix ϕϕ in the storage unit, or display the distance accumulation matrix ϕϕ or the image by the distance accumulation matrix ϕϕ on a display unit, or output the distance accumulation matrix ϕϕ or the image by the distance accumulation matrix ϕϕ through an output unit.

### Advantageous Effects of Invention

According to the present invention, scalar-valued statistical distances can be converted into a statistical distance matrix to refine the distances.

### BRIEF DESCRIPTION OF DRAWINGS

FIG. 1 is an explanatory list on “1. Symbols Related to Matrix.”

FIG. 2 is an explanatory list on “2. Symbols Related to Probability Theory” and “3. Symbols Related to Hierarchical Clustering.”

FIG. 3 is a hardware configuration diagram related to this embodiment.

FIG. 4 is an explanatory diagram of technology related to a statistical distance matrix visualization method of a first embodiment.

FIG. 5 is a flowchart related to the statistical distance matrix visualization method of the first embodiment.

FIG. 6 is an illustration illustrating image examples of airplanes, birds, cats, and dogs in CIFAR-10 dataset [6].

FIG. 7 is an illustration illustrating statistical distance matrices DDM, DDKL, DDB, and DDC for cases of airplanes and dogs, birds and dogs, and cats and dogs.

FIG. 8 is an illustration illustrating distance-accumulation images ϕϕM, ϕϕKL, ϕϕB, and ϕϕC for the cases of airplanes and dogs, birds and dogs, and cats and dogs.

FIG. 9 is an explanatory diagram on hierarchical clustering processing.

FIG. 10 is an illustration illustrating hierarchical clustering results using a statistical distance matrix DDB for the case of airplanes and dogs.

FIG. 11 is an illustration illustrating hierarchical clustering results using the statistical distance matrix DDB for the case of birds and dogs.

FIG. 12 is an illustration illustrating hierarchical clustering results using the statistical distance matrix DDB for the case of cats and dogs.

FIG. 13 is an illustration illustrating a result of cutting out, from a distance-accumulation image ϕϕB for the case of airplanes and dogs, three types of low-value, medium, and high-value element areas in total.

FIG. 14 is an illustration illustrating a result of cutting out, from the distance-accumulation image ϕϕB for the case of birds and dogs, the three types of low-value, medium, and high-value element areas in total.

FIG. 15 is an illustration illustrating a result of cutting out, from the distance-accumulation image ϕϕB for the case of cats and dogs, the three types of low-value, medium, and high-value element areas in total.

FIG. 16 is a table illustrating an example of calculation results of ρ.

FIG. 17 is an explanatory diagram on related technology 1 concerning a statistical distance.

FIG. 18 is an explanatory diagram on related technology 2 concerning a cross-correlation matrix.

FIG. 19 is a flowchart of hierarchical clustering.

FIG. 20 is a flowchart related to a statistical distance matrix visualization method of a second embodiment.

FIG. 21 is a flowchart related to a statistical distance matrix visualization method of a third embodiment.

### DESCRIPTION OF EMBODIMENTS

### 1. Description of Symbols

First, symbols used in this specification will be described.

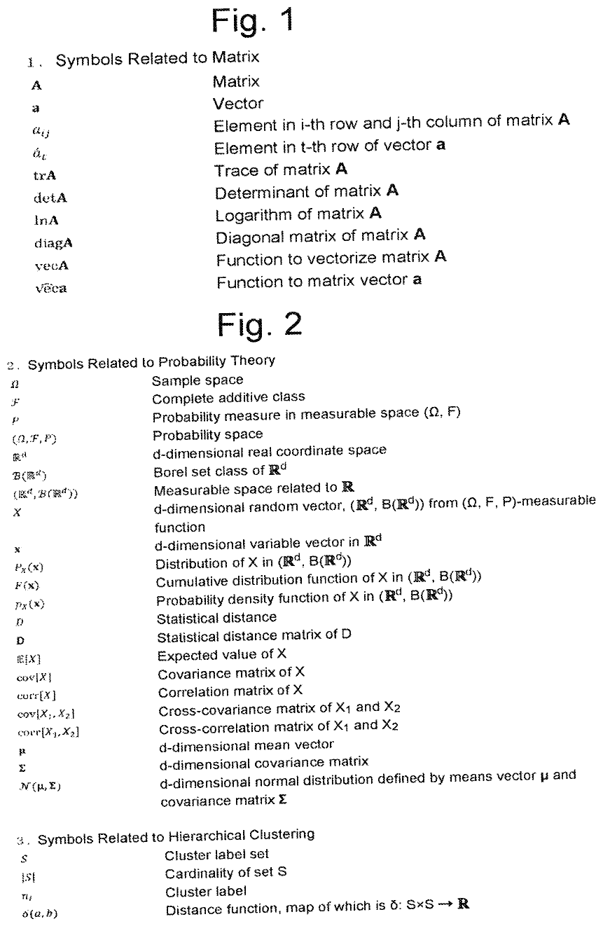

An explanatory list on “1. Symbols Related to Matrix” is illustrated in FIG. 1.

An explanatory list on “2. Symbols Related to Probability Theory” and “3. Symbols Related to Hierarchical Clustering” is illustrated in FIG. 2.

Note that a symbol “A” attached above a letter(s) is attached in the upper right of the letter(s) due to the restrictions on letters and symbols capable of being used in electronic application software or for convenience, but the symbol is the same as that attached above the letter(s) as will be expressed in equations. Further, as expressed in equations and the like, although bold letters such as a denote vectors, and bold letters A, D, μ, Σ, and the like denote matrices, they are denoted as “aa” and the like to denote vectors, and those corresponding to the bold letters A, D, μ, Σ, and the like are denoted as AA, DD, μμ, ΣΣ to denote matrices, respectively, due to the restrictions or for convenience. Further, as expressed in equations and the like, blackboard bold letters R, E, and the like are denoted as R, E, and the like due to the restrictions or for convenience. Further, [1], [2], . . . indicate numbers of references to be described later (see “11. References”).

### 2. Statistical Distance

Definition 1:

In general, when a probability space (Ω, F, P) is given, a cumulative distribution function for a d-dimensional random vector X1 having a distribution Px in a measurable space (Rd, B(Rd)) is F1(xx):=P(X1≤xx)=Px((−∞, xx]), x∈Rd (“:=” means to define). When F1(xx) is continuous with respect to a variable xx, pX(xx):=dF1(xx)/dxx is called a probability density function of X1. Similarly, when another probability space (Ω, F, Q) is given, a cumulative distribution function for a d-dimensional random vector X2 having a distribution Qx in the measurable space (Rd, B(Rd)) is F2(xx):=Q(X2 xx)=Qx((−∞, xx]). When F2(xx) is continuous, probability density function qX(xx):=dF2(xx)/dxx of X2 is obtained. In general, pX(xx) and qX(xx) are abbreviated as p(xx) and q(xx), respectively.

Based on the definitions described above, some measures were introduced into statistics to represent dissimilarities between two probability density functions p(xx) and q(xx).

The Bhattacharya distance DB was proposed in [1] as a first measurement to quantify the dissimilarities (Equation (1)). Then, Chernoff Distance Dc that extends DB was introduced in [2]. Here, the square-root operator was replaced with an exponent coefficient s (Equation (2)). Kullback-Leibler divergence DKL formalized as in Equation (3) was proposed in [7]. Since it does not satisfy the metric axiom, it should be noted that it is not a metric. Further, Hellinger Distance DH introduced in [4] is defined by the Hellinger integral as in Equation (4) below, or in Equation (5) below.

$$[ Math . 1 ]$$

$${D}_{B} := - ln {\int }_{{ℝ}^{d}} {p}^{\frac{1}{2}} ( x ) {q}^{\frac{1}{2}} ( x ) dx \qquad ( 1 )$$

$${D}_{C} := - ln {\int }_{{ℝ}^{d}} {p}^{s} ( x ) {q}^{1 - s} ( x ) dx \qquad ( 2 )$$

$${D}_{KL} := {\int }_{{ℝ}^{d}} [ p ( x ) - q ( x ) ] ln [ \frac{p ( x )}{q ( x )} ] dx \qquad ( 3 )$$

$${D}_{H}^{2} := \frac{1}{2} {{\int }_{{ℝ}^{d}} [ {p}^{\frac{1}{2}} ( x ) - {q}^{\frac{1}{2}} ( x ) ]}^{2} dx \qquad ( 4 )$$

$${D}_{H} := \frac{1}{\sqrt{2}} {\int }_{{ℝ}^{d}} {‖ {p}^{\frac{1}{2}} ( x ) - {q}^{\frac{1}{2}} ( x ) ‖}_{2} dx \qquad ( 5 )$$

All of these measures give only scalar dissimilarities between the two probability density functions p(xx) and q(xx) regardless of the dimension d of the corresponding random vector.

### 3. Statistical Distance Matrix

First, a cross-correlation matrix RR widely used as a conventional distance matrix will be described. When two populations (vector sets) {aak} and {bbk} having d-dimensional random vectors X1 and X2, k=1, . . . , N are given according to the normal distributions N(μμ1, ΣΣ1) and N(μμ2, ΣΣ2), respectively, X1 and X2 mean vectors μμ1, μμ2∈Rd, and covariance matrices ΣΣ1, ΣΣ2∈Rd×d can be obtained from Equations (19) and (37).

$$[ Math . 2 ]$$

$${μ}_{1} := 𝔼 [ {X}_{1} ] = \frac{1}{N} {\sum }_{k = 1}^{N} {a}_{k} , \qquad ( 19 )$$

$${\sum }_{1} := cov [ {X}_{1} ] = 𝔼 [ ( {X}_{1} - 𝔼 [ {X}_{1} ] ) {( {X}_{1} - 𝔼 [ {X}_{1} ] )}^{⊤} ] = \frac{1}{N - 1} {\sum }_{k = 1}^{N} [ ( {a}_{k} - {μ}_{1} ) {( {a}_{k} - {μ}_{1} )}^{⊤} ]$$

$${μ}_{2} := 𝔼 [ {X}_{2} ] = \frac{1}{N} {\sum }_{k = 1}^{N} {b}_{k} , \qquad ( 37 )$$

$${\sum }_{2} := cov [ {X}_{2} ] = 𝔼 [ ( {X}_{2} - 𝔼 [ {X}_{2} ] ) {( {X}_{2} - 𝔼 [ {X}_{2} ] )}^{⊤} ] = \frac{1}{N - 1} {\sum }_{k = 1}^{N} [ ( {b}_{k} - {μ}_{2} ) {( {b}_{k} - {μ}_{2} )}^{⊤} ] .$$

Based on the above equations, the cross-correlation matrix RR is calculated in Equation (38). Here, ΣΣ1, 2 is a cross-covariance matrix of X1 and X2, and diag(ΣΣ) is a diagonal matrix of the matrix ΣΣ.

$$[ Math . 3 ]$$

$$R := corr [ {X}_{1} , {X}_{2} ] = {( diag {\sum }_{1} )}^{- \frac{3}{2}} {\sum }_{1 , 2} {( diag {\sum }_{2} )}^{- \frac{1}{2}} , \qquad ( 38 )$$

$${\sum }_{1 , 2} := cov [ {X}_{1} , {X}_{2} ] = 𝔼 [ ( {X}_{1} - 𝔼 [ {X}_{1} ] ) {( {X}_{2} - 𝔼 [ {X}_{2} ] )}^{⊤} ] = \frac{1}{N - 1} {\sum }_{k = 1}^{N} [ ( {a}_{k} - {μ}_{1} ) {( {b}_{k} - {μ}_{2} )}^{⊤} ]$$

Here, since there are only diagonal components of ΣΣ1 and ΣΣ2 in diag(ΣΣ1) and diag(ΣΣ2), it should be noted that information is lost.

On the other hand, the present invention and/or this embodiment proposes a new statistical distance matrix obtained by converting a scalar-valued statistical distance through a de-trace operation. To make the de-trace operation easier to understand, Mahalanobis Distance DM [9] regarded as a specific case of the Bhattacharya distance DB is first introduced. Like the cross-correlation matrix, when there are two populations {aak} and {bbk} having mean vectors μμ1, μμ2∈Rd and covariance matrices ΣΣ1, ΣΣ2∈Rd×d, respectively, the Mahalanobis Distance DM between the two populations is expressed in a quadratic form below.

$$[ Math . 4 ]$$

$$\begin{matrix}{D}_{M} = {( {μ}_{1} - {μ}_{2} )}^{⊤} {\sum }^{- 1} ( {μ}_{1} - {μ}_{2} ) \\ = tr \{ ( {μ}_{1} - {μ}_{2} ) {( {μ}_{1} - {μ}_{2} )}^{⊤} {\sum }^{- 1} \} = {trD}_{M}\end{matrix} \qquad ( 6 )$$

Here, it is assumed that ΣΣ=ΣΣ1=ΣΣ2. This quadratic form can be transformed to a trace form as described in the second line of Equation (6). The Mahalanobis Distance Matrix DDM can be obtained in Equation (14) by removing the trace of the matrix.

[Math. 5]

D_{M}=(μ₁−μ₂)(μ₁−μ₂)¹Σ⁻¹ (14)

By contrast, the Bhattacharya distance DB corresponding to Bhattacharya Distance Matrix DDB needs to be defined in a continuous measurable space according to the Definition 1. In the present invention and/or this embodiment, the d-dimensional random vectors X1 and X2 from the two populations (vector sets) {aak} and {bbk} are assumed to follow two normal distributions N(μμ1, ΣΣ1) and N(μμ2, ΣΣ2), respectively, and DB between X1 and X2 is defined as in Equation below. Note that the detailed proof is presented in “10. Appendix: Derivation of Bhattacharya Distance DB (Equation (7))” to be described later.

$$\begin{matrix}[ Math . 6 ] & \\ \begin{matrix}{D}_{H} = \frac{1}{4} {( {µ}_{1} - {µ}_{2} )}^{1} {( {Σ}_{1} + {Σ}_{2} )}^{- 1} ( {µ}_{1} - {µ}_{2} ) + \\ \frac{1}{2} ln ( det {Σ}_{1}^{- \frac{1}{2}} det ( \frac{{Σ}_{1} + {Σ}_{2}}{2} ) det {Σ}_{1}^{- \frac{1}{2}} ] \\ = tr \{ \frac{1}{4} ( {µ}_{1} - {µ}_{2} ) {( {µ}_{1} - {µ}_{2} )}^{⊤} {( {Σ}_{1} + {Σ}_{2} )}^{- 1} + \\ \frac{1}{2} [ ln ( \frac{{Σ}_{1} + {Σ}_{2}}{2} ) - ln ( {Σ}_{1}^{- \frac{1}{2}} {Σ}_{2}^{- \frac{1}{2}} ) ] \} = tr {D}_{H}\end{matrix} & ( 7 )\end{matrix}$$

Since the first term of Equation (7) is similar to Equation (6), it can be transformed to the trace form like in Equation (6). Further, the second term of Equation (7) as a determinant natural logarithm function can also be changed to the trace form based on Equations below.

[Math. 7]

detAdetB=det(AB) (8)

ln(detA)=tr(lnA) (9)

tr[ln(AB)]=tr(lnA)+tr(lnB) (10)

Here, when AA and BB are two positive definite matrices in Rd×d, all the above equations hold. Next, the Bhattacharya Distance Matrix DDB is expressed in Equation (15) by dissolving the trace.

$$\begin{matrix}[ Math . 8 ] & \\ {D}_{H} = \frac{1}{4} ( {µ}_{1} - {µ}_{2} ) {( {µ}_{1} - {µ}_{2} )}^{⊤} {( {Σ}_{1} + {Σ}_{2} )}^{- 1} + \frac{1}{2} [ ln ( \frac{{Σ}_{1} + {Σ}_{2}}{2} ) - ln ( {Σ}_{1}^{- \frac{1}{2}} {Σ}_{2}^{- \frac{1}{2}} ) ] & ( 15 )\end{matrix}$$

The Chernoff Distance DC between the two normal distributions N(μμ1, ΣΣ1) and N(μμ2, ΣΣ2) is defined as in Equation below. This can also be derived by a method indicated in “10. Appendix: Derivation of Bhattacharya Distance DB (Equation (7))” to be described later.

$$\begin{matrix}[ Math . 9 ] & \\ \begin{matrix}{D}_{C} = \frac{1}{2} s ( 1 - s ) {{( {µ}_{1} - {µ}_{2} )}^{1} [ ( 1 - s ) {Σ}_{1} + s {Σ}_{2} ]}^{- 1} ( {µ}_{1} - {µ}_{2} ) + \\ \frac{1}{2} ln \{ det {Σ}_{1}^{s - 1} det [ ( 1 - s ) {Σ}_{1} + s {Σ}_{2} ] det {Σ}_{2}^{- s} \} \\ = tr \{ \frac{1}{2} s ( 1 - s ) ( {µ}_{1} - {µ}_{2} ) {( {µ}_{1} - {µ}_{2} )}^{⊤} {⌊ ( 1 - s ) {Σ}_{1} + s {Σ}_{2} ⌋}^{- 1} + \\ \frac{1}{2} \{ ln [ ( 1 - s ) {Σ}_{1} + s {Σ}_{2} ] - ln ( {Σ}_{1}^{1 - s} {Σ}_{2}^{s} ) \} \} \\ = tr {D}_{C} , s ∈ [ 0 , 1 ]\end{matrix} & ( 11 )\end{matrix}$$

After transformation to the trace form, the corresponding distance matrix DDC is obtained as in Equation (16) by dissolving the trace.

$$\begin{matrix}[ Math . 10 ] & \\ {D}_{C} = \frac{1}{2} s ( 1 - s ) ( {µ}_{1} - {µ}_{2} ) {{( {µ}_{1} - {µ}_{2} )}^{⊤} [ ( 1 - s ) {Σ}_{1} + s {Σ}_{2} ]}^{- 1} + \frac{1}{2} \{ ln [ ( 1 - s ) {Σ}_{1} + s {Σ}_{2} ] - ln ( {Σ}_{1}^{1 - s} {Σ}_{2}^{s} ) ] , s ∈ [ 0 , 1 ] & ( 16 )\end{matrix}$$

Since it is considered that the Chernoff Distance DC and the distance matrix DDC thereof are extended from DB and DDB and the exponent coefficient s can be adjusted according to a calculation request, it is considered to have the ability to adapt flexibly to complex data.

The Kullback-Leibler Divergence DKL between the two normal distributions N(μμ1, ΣΣ1) and N(μμ2, ΣΣ2) is defined as in Equation below.

$$\begin{matrix}[ Math . 11 ] & \\ \begin{matrix}{D}_{KL} = \frac{1}{2} {( {µ}_{1} - {µ}_{2} )}^{1} {( {Σ}_{1} + {Σ}_{2} )}^{- 1} ( {µ}_{1} - {µ}_{2} ) + \\ \frac{1}{2} tr ( {Σ}_{1}^{- 1} {Σ}_{2} + {Σ}_{2}^{- 1} {Σ}_{1} + 2 {I}_{d} ) \\ = tr \{ \frac{1}{2} ( {µ}_{1} - {µ}_{2} ) {( {µ}_{1} - {µ}_{2} )}^{⊤} {( {µ}_{1} + {µ}_{2} )}^{- 1} + \\ \frac{1}{2} ( {Σ}_{1}^{- 1} {Σ}_{2} + {Σ}_{2}^{- 1} {Σ}_{1} + 2 {I}_{d} ) \} = tr {D}_{KL}\end{matrix} & ( 12 )\end{matrix}$$

Here, IId is a d-dimensional identity matrix. A corresponding distance matrix DDKL is obtained by writing the trace form thereof as in Equation (12) and dissolving the trance as in Equation (17). It should be noted that there exists no logarithm operation in the second term of Equation (17).

$$\begin{matrix}[ Math . 12 ] & \\ {D}_{KL} = \frac{1}{2} ( {µ}_{1} - {µ}_{2} ) {( {µ}_{1} - {µ}_{2} )}^{⊤} {( {Σ}_{1} + {Σ}_{2} )}^{- 1} + \frac{1}{2} ( {Σ}_{1}^{- 1} {Σ}_{2} + {Σ}_{2}^{- 1} {Σ}_{1} + 2 {I}_{d} ) & ( 17 )\end{matrix}$$

The Hellinger Distance matrix DDH between the two normal distributions N(μμ1, ΣΣ1) and N(μμ2, ΣΣ2) is found as in Equation below.

$$\begin{matrix}[ Math . 13 ] & \\ \begin{matrix}{D}_{H} = {[ 1 - exp ( - {D}_{B} ) ]}^{\frac{1}{2}} \\ = {[ 1 - exp ( - tr {D}_{B} ) ]}^{\frac{1}{2}}\end{matrix} & ( 13 )\end{matrix}$$

However, since Equation (13) can be considered as a function with respect to DDB but cannot be changed into a complete trace form, it was found that the Hellinger distance DH has no distance matrix DDH. Here, each statistical distance matrix is defined as DD:=[δuv]∈Ud×d,u,v=1, . . . , d.

### 4. Hardware and Program

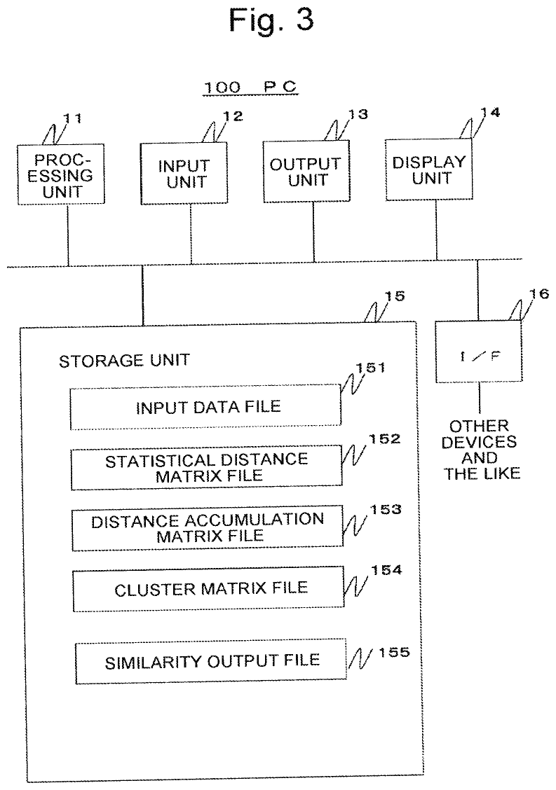

FIG. 3 is a hardware configuration diagram of the present embodiment.

This hardware has a processing unit 11 as a central processing unit (CPU), an input unit 12, an output unit 13, a display unit 14, a storage unit 15, and an interface unit (I/F) 16. Further, the processing unit 11, the input unit 12, the output unit 13, the display unit 14, the storage unit 15, and the interface unit (I/F) 16 are connected by appropriate connection means such as a star or a bus. The storage unit 15 contains various files such as an input data file 151, a statistical distance matrix file 152, a distance matrix file 153, a cluster matrix file 154, and an output file 155.

In each file of the storage unit 15, data listed in “1. Symbols Related to Matrix” and other appropriate data can be stored as necessary. The processing unit 11 can read data stored in the storage unit 15 and/or write data to the storage unit 15 as necessary. The processing unit 11 can input data from the input unit 12 and the I/F 16 as necessary. The processing unit 101 can execute respective processes of the present embodiment based on input/output data to execute calculations of various statistical distance matrices, hierarchical clustering processing, similarity determination, and the like. Further, the processing unit 11 can output data to the output unit 13 to output the data to other devices/units through the I/F 16 and to the display unit 14 as necessary.

The statistical distance matrix calculation method or device/system of the present invention and/or the present embodiment can be provided by a statistical distance matrix calculation program to cause a computer to execute each step thereof, by a computer-readable recording medium on which a calculation program is recorded, by a program product including the statistical distance matrix calculation program and loadable into an internal memory of the computer, by the computer such as a server including the program, or the like.

Further, the statistical distance matrix visualization method or device/system of the present invention and/or the present embodiment can be provided by a statistical distance matrix visualization program to cause a computer to execute each step thereof, by a computer-readable recording medium on which a visualization program is recorded, by a program product including the statistical distance matrix visualization program and loadable into the internal memory of the computer, by the computer such as a server including the program, or the like.

### 5. Statistical Distance Matrix Calculation/Visualization, and Application Examples

### 5. 1. First Embodiment

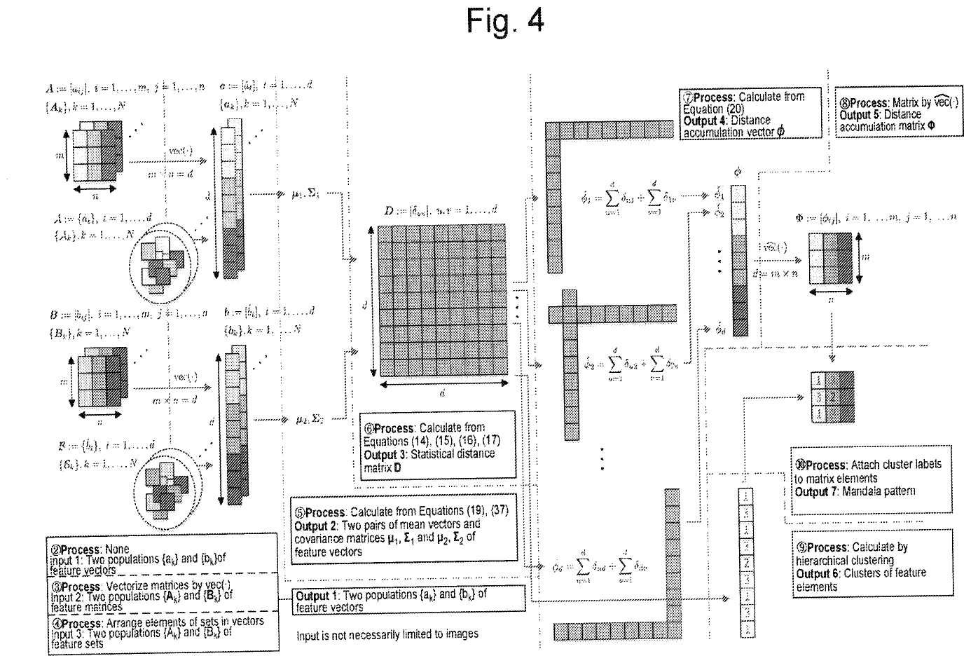

An explanatory diagram of technology related to a statistical distance matrix calculation/visualization method of a first embodiment is illustrated in FIG. 4.

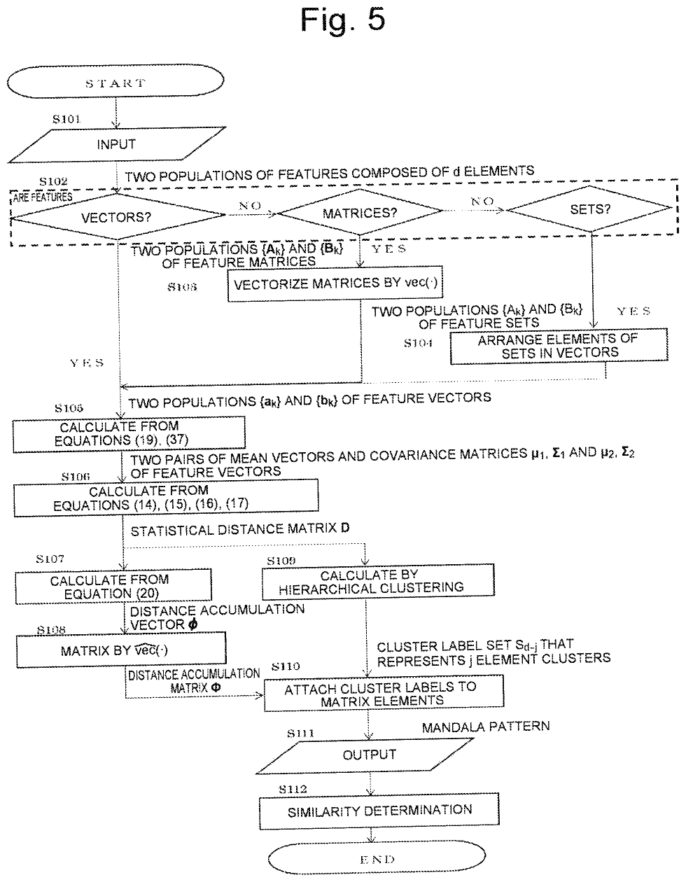

A flowchart on the statistical distance matrix calculation/visualization method of the first embodiment is illustrated in FIG. 5.

A process in each step executed by the processing unit 11 will be described below.

(Step S101)

The processing unit 11 inputs data as targets for comparison from the input unit 12, the storage unit 15 (input data file 151), or any other device through the I/F 16.

Input 0 and Output 0 are two populations (data) of features composed of d elements.

Here, the feature forms of the input populations (data) may be any of feature vectors, feature matrices, and feature sets.

(Step S102)

When the features of the input data are vectors (Condition 1), the processing unit 11 proceeds to step S105.
Here,
Input 1: Two populations {aak} and {bbk} of feature vectors
Output 1: Two populations {aak} and {bbk} of feature vectors.
Here,

aa:={a′t},t=1, . . . ,d

{aak},k=1, . . . ,N

bb:={b′t},t=1, . . . ,d

{bbk},k=1, . . . ,N

When the features of the input data are matrices (Condition 2), the processing unit 11 proceeds to step S103.

When the features of the input data are sets (Condition 3), the processing unit 11 proceeds to step S104.

(Step S103)

When the features of the input data are matrices (Condition 2), the processing unit 11 vectorizes the matrices by vec(⋅).
Here,
Input 2: Two populations {AAk} and {BBk} of feature matrices
Output 1: Two populations {aak} and {bbk} of feature vectors.
Here,

AA:={aij},i=1, . . . m,j=1, . . . ,n,

{AAk},k=1, . . . ,N

BB:={bij},i=1, . . . ,m,j=1, . . . ,n,

{BBk},k=1, . . . ,N

The processing unit 11 vectorizes the input feature matrices {AAk}, {BBk} by the function vec(⋅) to set feature vectors {aak}, {bbk}. In other words, m rows and n columns of each matrix are arranged to form a vector of d (d=m×n) elements. For example, elements are arranged in such a manner as to arrange the first column with the first to the m-th elements, the second column with the m+1-th to 2m-th elements, the third column with the 2m+1-th to 3m-th elements, . . . , and matrixed. Note that the elements may also be arranged row by row in order.

(Step S104)

When the features of the input data are sets (Condition 3), the processing unit 11 arranges elements of the sets in vectors.
Here,
Input 3: Two populations {AA′k} and {BB′k} of feature sets
Output 1: Two populations {aak} and {bbk} of feature vectors.
Here, {AA′k}, {BB′k} express the sets.

AA′:={a′t},t=1, . . . ,d

{AA′k},k=1, . . . ,N

BB′:={b′t},t=1, . . . ,d

{BB′k},k=1, . . . ,N

Note that, for example, when input data are images as in examples to be described later, feature matrices are input, and step S103 is executed. Further, features of input data may be predetermined and limited to omit any one or two processes steps S102, S103, and S104 according to the determined features.

As an example, the CIFAR-10 dataset [6] was used to test the effects of statistical distance matrices. This dataset contains 60,000 images in total, where 6,000 images with an RGB image size of 32×32 pixels are contained, respectively, in ten classes. In this example, the processing unit 11 inputs images AA and BB in step S101, determines that the images are feature matrices in step S102, and executes step S103.

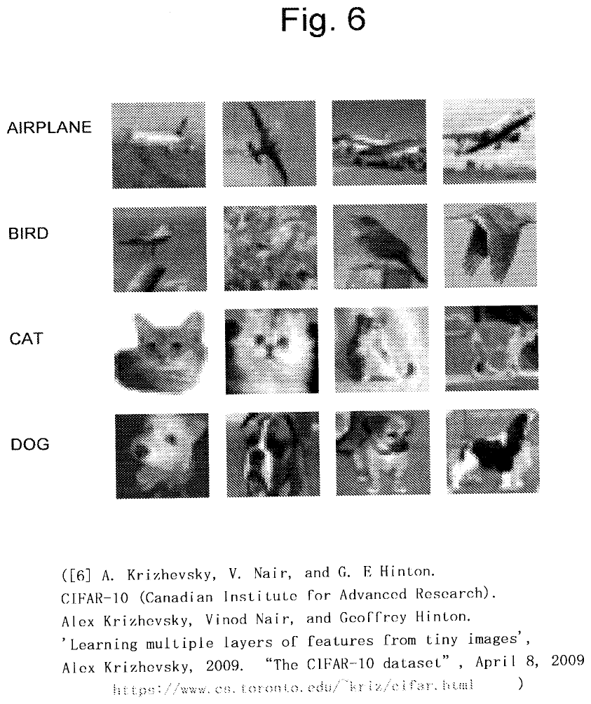

FIG. 6 is an illustration illustrating image examples of airplanes, birds, cats, and dogs in the CIFAR-10 dataset [6].

As illustrated, in order to simplify the calculations and obtain distinguishable results, only the distance matrices between airplanes and dogs, birds and dogs, and cats and dogs were so calculated that the similarities between two classes could range in ascending order from weak to strong. A value range of image pixels for all images AA:=[aij]∈Um×n, i=1, . . . , m,j=1, n is designated to U=[0, 1], and image forms are reconstructed by the function vec(⋅) to vectorize the images as feature element vectors aa:=[a″t]=vecAA∈Rd×1, t=1, d. Here, d=m×n. Then, the reconstructed two-class image sets {aak} and {bbk}, k=1, . . . , N are considered as two populations having d-dimensional random vectors X1 and X2 according to the normal distributions N(μμ1, ΣΣ1) and N(μμ2, ΣΣ2), respectively. Here, X1 and X2 mean vectors μμ1, μμ2∈Rd, and covariance matrices ΣΣ1, ΣΣ2∈Rd×d are obtained from Equations (19) and (37).

In this example, the image sets {aak} and {bbk} were set as image sets of airplanes and dogs, birds and dogs, and cats and dogs in this order. Since only training images were used in each class, N was set to 5000.

(Step S105)

The processing unit 11 calculates the population mean vectors and the covariance matrices from Equations (19) and (37).
Here,
Input: Output 1 of any one of steps S102, S103, and S104
Output 2: Two pairs of mean vectors and covariance matrices μμ1, ΣΣ1 and μμ2, ΣΣ2 of feature vectors.

In the present invention and/or the present embodiment, the two pairs of mean vectors and covariance matrices μμ1, ΣΣ1 and μμ2, ΣΣ2 were used, as an example, for calculating statistical distance matrices. However, these parameters are not limited, and can be determined as appropriate according to the data size and the like.

(Step S106)

The processing unit 11 calculates statistical distance matrices from any one or more of predetermined Equations (14), (15), (16), and (17).
Here,
Input: Output 2 of step S105
Output 3: Statistical distance matrix DD.
Here,

DD:={δuv},u,v=1, . . . ,d

Which of Equations (14), (15), (16), and (17) is used as the statistical distance matrix DD may be set from the input unit 12 or the like at an appropriate stage, or may be set by default. Further, when two or more Equations are set, the following processes are executed for each Equation, respectively.

Further, as for the statistical distance, a statistical distance that can be represented in a known, well-known, or any other trace form composed of terms, such as those of a quadratic form and a determinant natural logarithm function, can be used in addition to the examples of Equations (14), (15), (16), and (17) described above, and the known, well-known, or any other statistical distance can be used to calculate the statistical distance matrix through the de-trace operation.

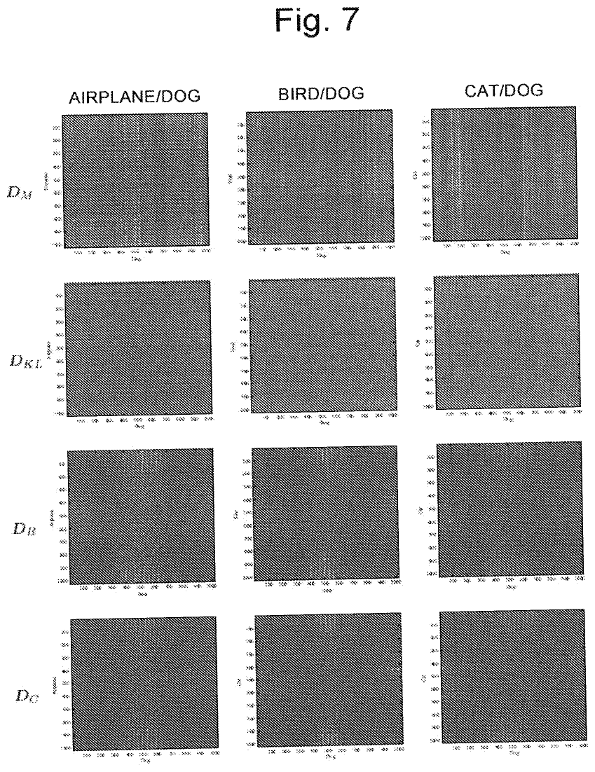

FIG. 7 is an illustration illustrating statistical distance matrices DDM, DDKL, DDB, and DDC for cases of airplanes and dogs, birds and dogs, and cats and dogs.

For respective cases, the mean vectors μμ1 and μμ2, and the covariance matrices ΣΣ1 and ΣΣ2 calculated in Equations (19) and (37) were substituted into Equations (14) to (17), respectively, to calculate the four statistical distance matrices DDM, DDKL, DDB, and DDC in three cases.

As illustrated, in this example, all of DDM and DDKL appeared chaotic and uninformative in the three cases. By contrast, the local distances δuv with high values represent grid-like patterns in the middle of DDB and DDC, where the exponent coefficient s in DDC was set to 0.3. These high-valued local distances can be effectively used to distinguish between aak and bbk when pixels a′t and b′t of the images aak and bbk are regarded as corresponding elements of the random vectors X1 and X2 in the measurable space, respectively. Considering that DDB is a particular case of DDC where s is set to ½, statistical distance matrices like DDC are considered to be valid.

(Step S107)

The processing unit 11 calculates a distance accumulation vector from Equation (20).
Here,
Input: Output 3 of step S106
Output 4: Distance accumulation vector φφ.

$$\begin{matrix}[ Math . 14 ] & \\ {\dot{ϕ}}_{t} = {\sum }_{u = 1}^{d} {δ}_{ut} + {\sum }_{v = 1}^{d} δ \text{?} & ( 20 )\end{matrix}$$

$$\text{?} \text{indicates text missing or illegible when filed}$$

In other words, the processing unit 11 accumulates all of related or predetermined local distances as in Equation (20) for each of the image pixels a′t and b′t, and assigns obtained values to new pixels to form a distance accumulation vector φφ:=[φ′t]∈Rd×1, t=1, . . . , d.

(Step S108)

The processing unit 11 arranges the distance accumulation vectors in order by the function vec\hat{ }(⋅) and matrixes the distance accumulation vectors into the statistical distance matrix. In other words, the vectors of d elements are arranged to form a matrix with m rows and n columns that satisfies m×n=d.
Here,
Input: Output 4 of step S107
Output 5: Distance accumulation matrix ϕϕ.

Here, the distance accumulation matrix (distance-accumulation image) ϕϕ:=[φij]=vec\hat{ }(φφ), i=1, . . . , m, j=1, . . . , n is composed of distance accumulation vectors φφ, and used as a method of representing the distance matrix. Here, vec\hat{ }(⋅) was set as a reverse process of vec(⋅).

The processing unit 11 arranges, in order, d elements of the distance accumulation vectors φφ:=[φ′t],t=1, . . . , d input by the function vec\hat{ }(⋅) to form a matrix with m rows and n columns that satisfies m×n=d in order to set the matrix as the statistical distance matrix ϕϕ. In other words, the elements are arranged, such as to arrange the first column with φ″1 to φ′m, the second column with (p″m+1 to φ″2m, the third column with φ″2m+1 to φ′3m, . . . , and matrixed. Note that the elements may also be arranged row by row in order.

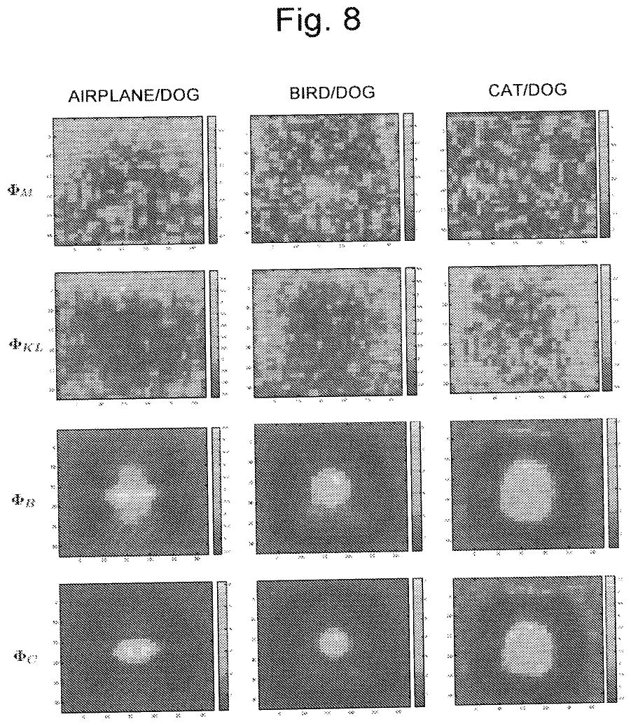

FIG. 8 is an illustration illustrating distance-accumulation images ϕϕM, ϕϕKL, ϕϕB, and ϕϕC for the cases of airplanes and dogs, birds and dogs, and cats and dogs.

The effects of the statistical distance matrices can be more clearly reflected in their distance-accumulation images than themselves. As illustrated, the distance-accumulation images ϕϕM and ϕϕKL of DDM and DDKL were disordered, and the distance-accumulation images ϕϕB and ϕϕC of DDB and DDC exhibited ordered patterns. The main representation is that the high-valued pixels are all concentrated in the center of the distance-accumulation image, exhibiting a distribution similar to a circle or an ellipse. In the case of classes with low similarities, such as airplanes and dogs, the number of high-valued pixels is greater and their locations are more concentrated in the center of the image. By contrast, between classes with high similarities, such as cats and dogs, high-valued pixels are fewer and concentrated in the center of the image more broadly along with middle-value pixels. Therefore, the distance matrix imaging method can simultaneously quantify the differences between the image pixels of every two classes in degree and position.

(Step S109)

After step S106, on the other hand, the processing unit 11 calculates clusters of feature elements by hierarchical clustering for the statistical distance matrix DD to find cluster label sets. In other words, the processing unit 11 finds sets of cluster labels attached to d element IDs based on the d-row×d-column statistical distance matrix DD.
Here,
Input: Output 3 of step S106
Output 6: Cluster label set Sd-j that represents j element clusters.

The processing unit 11 arranges the cluster labels of d elements in the input cluster label sets by the function vec\hat{ }(⋅) in order of element ID like in the case of vectors to form a matrix with m rows and n columns that satisfies m×n=d and set the matrix as a cluster matrix. In other words, the elements are arranged, such as to arrange the first column with the first to the m-th elements, the second column with the m+1-th to 2m-th elements, the third column with the 2m+1th to 3m-th elements, . . . , and matrixed. Note that the elements may also be arranged row by row in order.

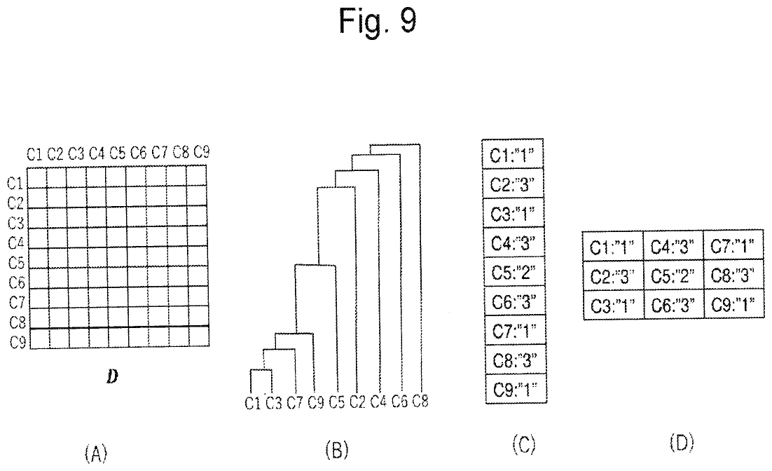

An explanatory diagram on hierarchical clustering processing is illustrated in FIG. 9.

In this example, as in FIG. 9(A), the statistical distance matrix DD has nine rows and nine columns, and the processing unit 11 finds a set of cluster labels attached to nine element IDs (C1, C2, . . . , C9) corresponding to respective row numbers or column numbers.

Here, as an example, a tree diagram as in FIG. 9(B) is obtained, and further, each cluster label is given to each element ID as in FIG. 9(C).
C1: “1”, C2: “3”, C3:“1”,
C4: “3”, C5: “2”, C6:“3”,
C7: “1”, C8: “3”, C9: “1”.

A known, well-known, or appropriate processing can be used as the hierarchical clustering processing.

For example, an easy-to-understand example of hierarchical clustering is given on the site below.

http://www.snap-tck.com/room04/c01/stat/stat20/stat2002.html

Referring to this example, an overview will be described below.

The hierarchical clustering has element IDs corresponding to respective row numbers or column numbers for the statistical distance matrix DD. First, since a different cluster label is attached to each element, each cluster contains only one element. The processing unit 11 combines two clusters closest in distance δuv in the input statistical distance matrix DD. The distances between the combined two clusters and other clusters are compared, and the statistical distance matrix DD is so updated that a longer distance is set as a distance between a new cluster generated after being combined and any other cluster. The processing unit 11 repeats processing to further combine two clusters closest in distance δuv in the updated statistical distance matrix DD, update the cluster based on the longer distance, and update the statistical distance matrix DD until the clusters become one cluster. Thus, the processing unit 11 forms the tree diagram of cluster labels, and according to the tree diagram, the processing unit 11 divides the clusters into groups according to the preset number of clusters, and attaches cluster labels to the element IDs. The results are formed as a cluster label set. The processing unit 11 can further arrange the cluster label set in order of original element ID to matrix the cluster label set in order to form a cluster matrix. The processing unit 11 can store the cluster matrix in the storage unit 15 (cluster matrix file 154).

Further, an example of processing related to the hierarchical clustering will be described in “9. Clustering of Distance Matrix” to be described later.

Further, the processing is not limited to the hierarchical clustering, and known, well-known, or appropriate clustering processing may also be used.

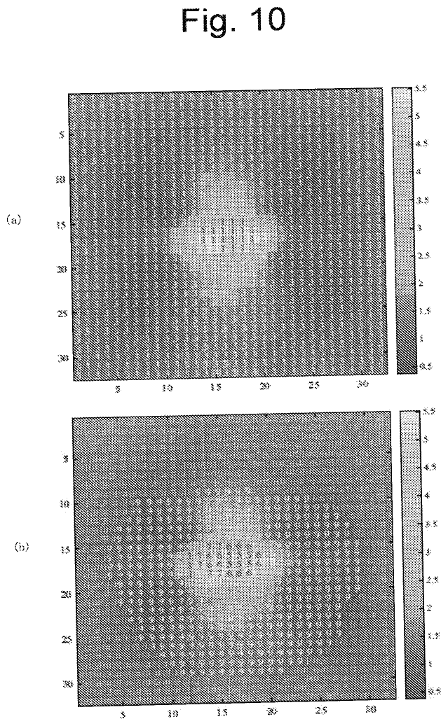

FIG. 10 is an illustration illustrating the hierarchical clustering results using the statistical distance matrix DDB for the case of airplanes and dogs (labeled distance-accumulation images ϕϕB, where (a): three clusters, and (b): ten clusters).

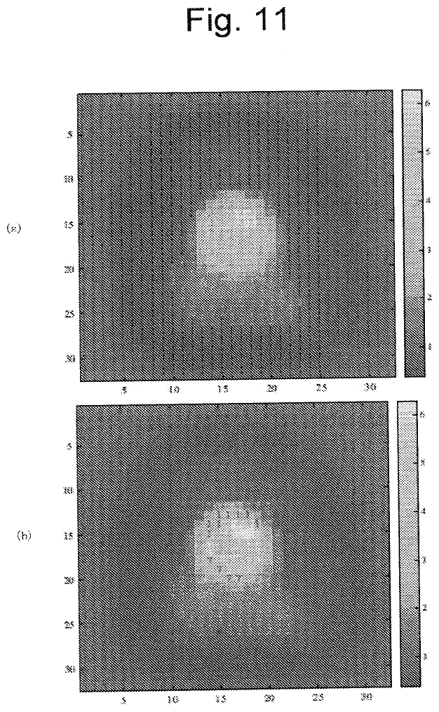

FIG. 11 is an illustration illustrating the hierarchical clustering results using the statistical distance matrix DDB for the case of birds and dogs (labeled distance-accumulation images ϕϕB, where (a): three clusters, and (b): ten clusters).

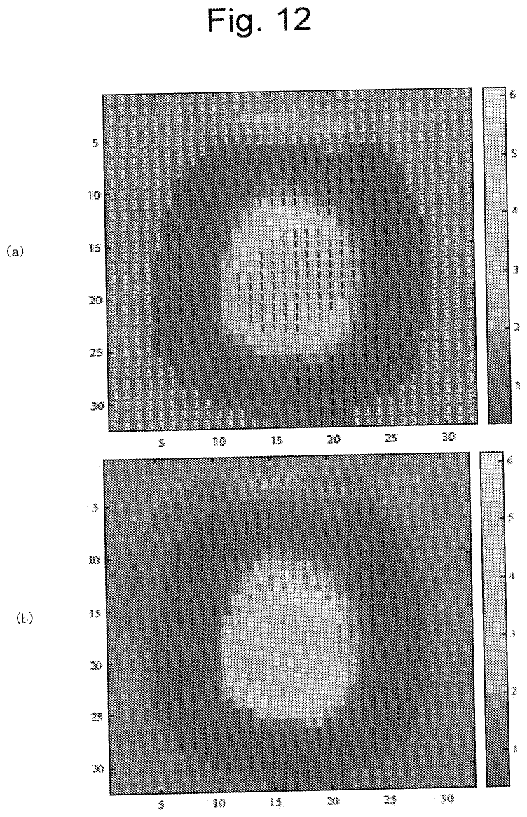

FIG. 12 is an illustration illustrating the hierarchical clustering results using the statistical distance matrix DDB for the case of cats and dogs (labeled distance-accumulation images ϕϕB, where (a): three clusters, and (b): ten clusters).

Here, based on the statistical distance matrix DDB, the processing unit 11 used a hierarchical clustering algorithm to be described later with reference to “9. Clustering of Distance Matrix” to cluster pixels (feature elements) of the distance-accumulation image ϕϕB. As illustrated in these illustrations, ϕϕB pixels were separated into three and ten clusters for the three cases of airplanes and dogs, birds and dogs, and cats and dogs, and labeled, respectively. The obtained cluster patterns are all circular or square (or elliptical, rectangular, or the like), which are symmetrical, and radiate from a center point. Such cluster patterns can be regarded as Mandalas. Therefore, the term “Information Mandala” was established to intuitively describe the clustering results of the statistical distance matrix. (Note that the word Mandala is a Sanskrit term meaning “sacred circle.” In various religious traditions, such as Hinduism, Buddhism, Jainism, and Shintoism, a mandala is used as a map to represent paradise, gods, or actual shrines. The mandala is circular or square, and designed with repeating colors, shapes, and patterns that radiate from a center point. When being precisely measured, the mandala has geometric symmetry.)

(Step S110)

The processing unit 11 attaches a cluster label (element label) to each matrix element.
Here,
Input: Output 6 of step S109 or output 5 of step S108
Output 7: Mandala pattern depending on similarities.

In this step, the processing unit 11 may also matrix the cluster set by the function vec\hat{ }(⋅) into a cluster matrix. In other words, the processing unit 11 can form a matrix with m rows and n columns that satisfies m×n=d by arranging the cluster labels of d elements in order of element ID like in the case of vectors. Alternatively, the processing unit 11 may also associate the cluster set with the distance accumulation matrix ϕϕ without actually forming the cluster matrix in step S109 or S110.

For example, in the example of FIG. 9, when the cluster label set is vectorized as illustrated in FIG. 9(D), the labels are nine, and the processing unit 11 matrixes the cluster label set into a cluster matrix with three rows and three columns by the processing of vec\hat{ }(⋅) so that the statistical distance matrix DD attaches cluster labels corresponding to the three rows and three columns thereof.

(Step S111)

The processing unit 11 can store, in the storage unit 15 (distance accumulation matrix file 153), the distance accumulation matrix ϕϕ with the cluster labels attached. Further, the processing unit 11 can display, on the display unit 14, the distance accumulation matrix ϕϕ as an image, for example, and/or output the results through the output unit 13 or the I/F 16.
Here,
Input: Output 7 of S110
Output: Output 7 of S110.

(Step S112)

The processing unit 11 determines the similarities between aa and bb from the pattern of the distance accumulation matrix ϕϕ. The processing unit 11 can store the determination result in the output file 154. Specific processing for similarity determination will be described later with reference to “6. Quantification of Mandala Pattern in Distance-accumulation image.”

Note that the processing unit 11 may store any one or more of data calculated/obtained in each of step S101 to step S112 and the output result appropriately in each file (the input data file 151, the statistical distance matrix file 152, the distance matrix file 153, the cluster matrix file 154, or the output file 155) of the storage unit 15, and can read the data or the output result therefrom as necessary. Further, the processing unit 11 may also display any one or more of data calculated/obtained in each of step S101 to step S112 or the output result on the display unit 14, and/or output the result through the output unit 13 or the I/F 16.

### 5. 2. Second Embodiment

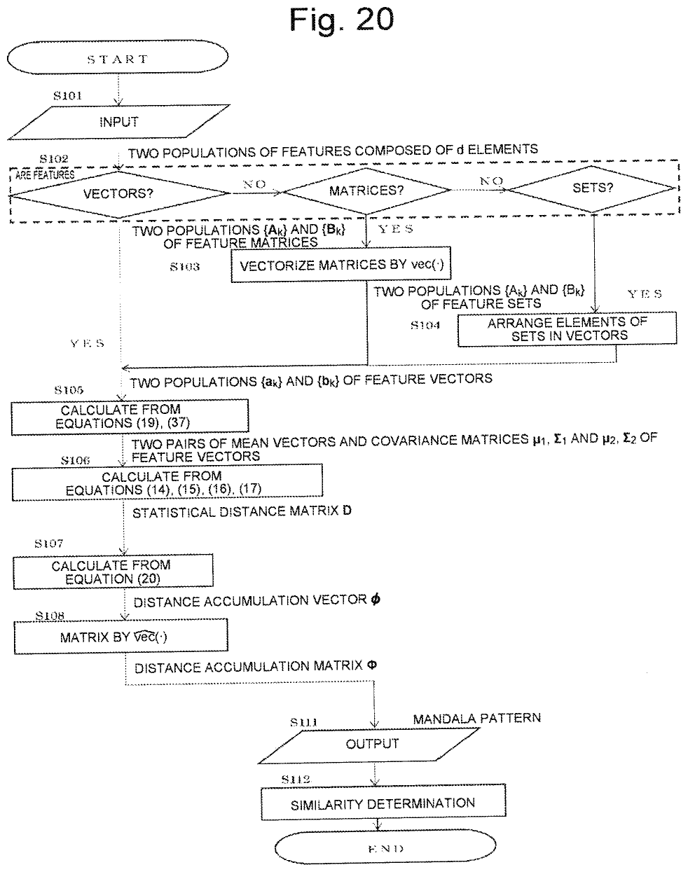

A flowchart related to a statistical distance matrix visualization method of a second embodiment is illustrated in FIG. 20.

The second embodiment is to omit steps S109 and S110 in the first embodiment.

(Step S101) to (Step S108)

The processing unit 11 executes the same processing as in the first embodiment.

(Step S111)

The processing unit 11 can display the distance accumulation matrix ϕϕ on the display unit 14 as an image, for example, and/or output the result through the output unit 13 or the I/F 16. (Note that no cluster label is attached.)

(Step S112)

The processing unit 11 executes the same processing as in the first embodiment.

The details of the other processing are the same as in the first embodiment.

### 5. 3. Third Embodiment

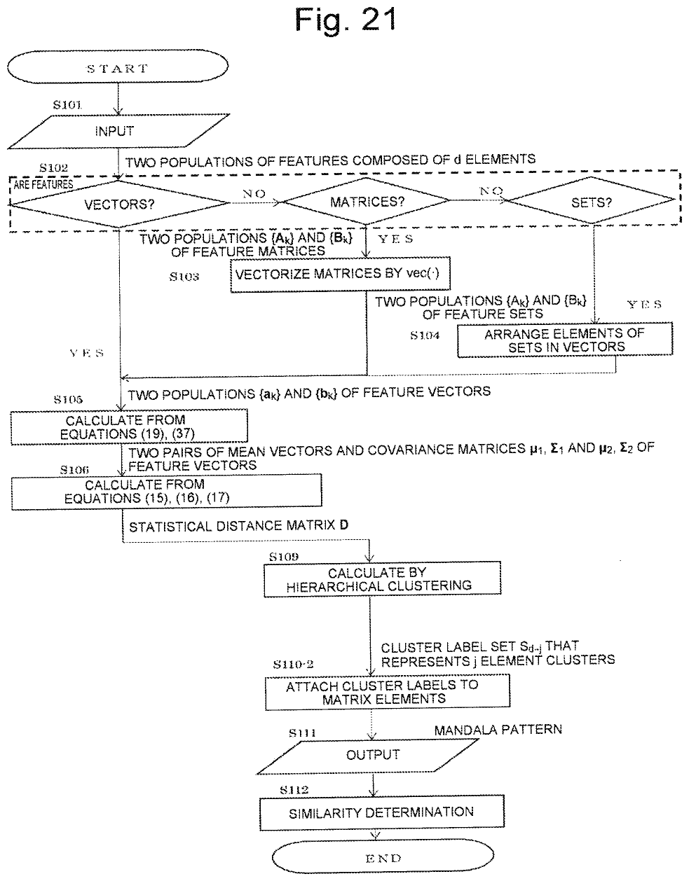

A flowchart related to a statistical distance matrix visualization method of a third embodiment is illustrated in FIG. 21.

The third embodiment is to omit step S107 and step S108 in the first embodiment, and replace step S110 with step S110-2.

(Step S101) to (Step S106), and (Step S109)

The processing unit 11 executes the same processing as in the first embodiment.

(Step S110-2)

The processing unit 11 matrixes the cluster label sets by the function vec\hat{ }(⋅) into a statistical distance matrix. In other words, d cluster label sets are arranged to form a matrix with m rows and n columns that satisfies m×n=d.
Here,
Input: Output 4 of step S109
Output 5: Cluster matrix.

(Step S111)

The processing unit 11 outputs the cluster label matrix.

(Step S112)

The processing unit 11 executes the same processing as in the first embodiment.

The details of the other processing are the same as in the first embodiment.

### 5. 4. Supplemental Effects of Third Embodiment

The value of each element in the distance accumulation matrix ϕϕ is a value obtained by accumulating local distances between the element and all of other elements in the distance matrix. Therefore, it is considered that the distance accumulation matrix ϕϕ is obtained by compressing the distance matrix, where the amount of information of the distance accumulation matrix ϕϕ is less than the distance matrix. Since no traces of the local distances also exist in the distance accumulation matrix ϕϕ, the distance matrix cannot be restored from the distance accumulation matrix ϕϕ.

On the other hand, since the tree diagram as a result of clustering is obtained by arranging elements hierarchically depending on the magnitude of the local distance in the distance matrix, all of the relative distance relationships between respective elements are contained. Therefore, a relative distance matrix can be restored from the tree diagram instead of the original, absolute distance matrix. The relationship of the tree diagram with the distance accumulation matrix ϕϕ is weak. Further, d cluster label sets {Sd-j}, j=d-i, i=1, d that represent j element clusters can be used to represent a Mandala pattern.

Although both the distance accumulation matrix ϕϕ and the clustering results represent Mandala patterns, these patterns are different. For example, as illustrated in (b) of FIG. 12, since clusters 2 and elements of ϕ with label 8 attached thereto have close values, both may not be able to be distinguished by setting a simple threshold, but can be distinguished by cluster label sets (element label sets) Sd-j (d=32×32, j=10) that represent 10 element clusters.

In the first embodiment, two types of Mandala patterns are united to make it further easier to understand how the results look like, but it does not matter for the Mandala patterns not to be united like in the second embodiment or the third embodiment.

### 6. Quantification of Mandala Pattern in Distance-Accumulation Image

(Measurement of Dissimilarities (Strength of Mandala Pattern) by Segmenting Distance-Accumulation Image)

The processing unit 11 can realize the quantification of a Mandala pattern in a distance accumulation matrix (distance-accumulation image) (the measurement of dissimilarities (strength of the Mandala pattern) by segmenting the distance-accumulation image) by executing processing below.

For all elements of the distance accumulation matrix (distance-accumulation image) ϕϕ:=[φij]=vec\hat{ }(φφ), i=1, . . . , m,j=1, . . . , n, the accumulation image is segmented by using two thresholds to cut out, from the image, three types of element areas in total, that is, low, medium, and high in terms of the value. An area obtained by combining the high-value element area and medium element area is called an effective element area due to having a lot of information. A value obtained by calculating an area ratio between the high-value element area and the effective element area (a ratio of the number of elements in the effective element area to the number of elements in the high-value element area) is considered to be dissimilarities between two classes, that is, the strength of the Mandala pattern.

A threshold θ1 for low-value elements and medium elements, and a threshold θ2 for medium elements and high-value elements are obtained respectively from Equations below.

θ1:=(⅓)φmax,θ2:=(⅔)φmax (42)

Here, φmax is the maximum value of elements in the distance-accumulation image ϕϕ. Based on these thresholds, the three types of low-value, medium, and high-value element areas Rlow, Rmedium, and Righ in total are defined respectively by Equations below.

Rlow:={(i,j)|φ(i,j)≤θ1,i=1, . . . ,m,j=1, . . . ,n} (43)

Rmedium:={(i,j)|φ(i,j)≤(i,j)≤θ2,i=1, . . . ,m,j=1, . . . ,n} (44)

Rhigh:={(i,j)|θ2≤φ(i,j),i=1, . . . ,m,j=1, . . . ,n} (45)

Then, an area ratio ρ between the high-value element area Rhigh and the effective element area Rmedium+Rhigh is represented by a ratio between Nhigh and Nmedium+Nhigh as the numbers of elements of Rhigh and Rmedium+Rhigh:

ρ:=Nhigh/(Nmedium+Nhigh) (46)

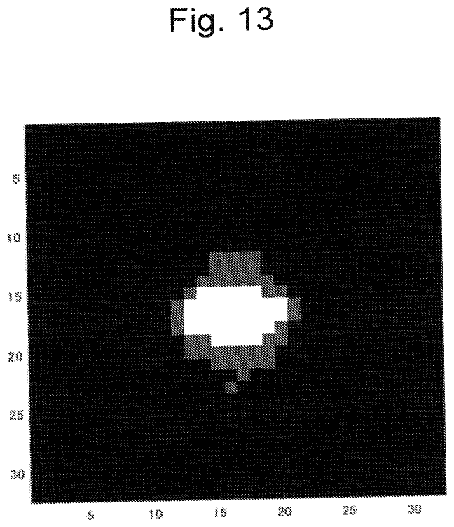

FIG. 13 is an illustration illustrating a result of cutting out, from the distance-accumulation image ϕϕB for the case of airplanes and dogs, three types of low-value, medium, and high-value element areas in total (Black: Low-value element area Rlow; Gray: Medium-value element area Rmedium; White: High-value element area Rhigh).

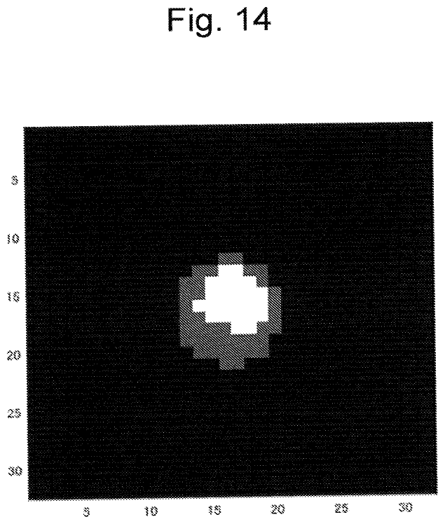

FIG. 14 is an illustration illustrating a result of cutting out, from the distance-accumulation image ϕϕB for the case of birds and dogs, three types of low-value, medium, and high-value element areas in total (Black: Low-value element area Rlow; Gray: Medium-value element area Rmedium; White: High-value element area Rhigh).

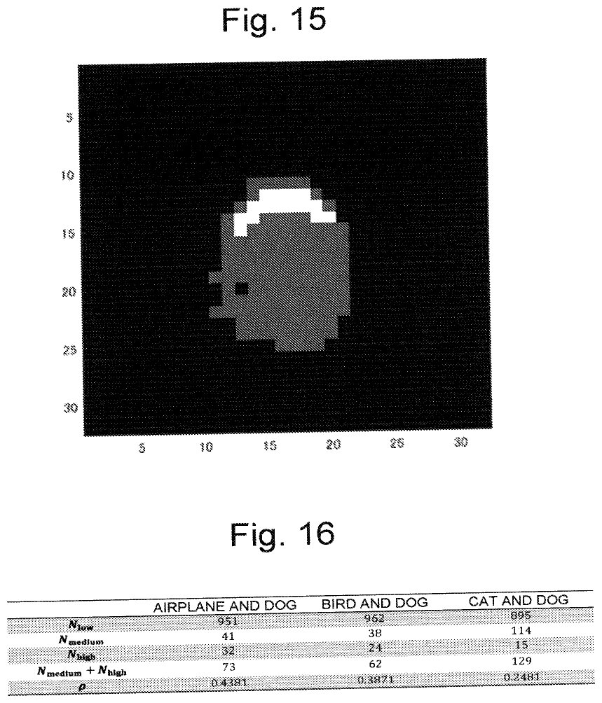

FIG. 15 is an illustration illustrating a result of cutting out, from the distance-accumulation image ϕϕB for the case of cats and dogs, three types of low-value, medium, and high-value element areas in total (Black: Low-value element area Rlow; Gray: Medium-value element area Rmedium; White: High-value element area Rhigh).

As illustrated in these illustrations, the values of Nlow, Nmedium, and Nhigh, respectively, for the cases of airplanes and dogs, birds and dogs, and cats and dogs, and the value of Nmedium+Nhigh are found by Equations (43) to (45), respectively, and the areas are calculated from Equation (46). The results are as illustrated in FIG. ## below.

FIG. 16 is a table illustrating an example of calculation results of ρ.

For the cases of airplanes and dogs, birds and dogs, and cats and dogs, the values of ρ are arranged in order from highest to lowest, and ρ is considered to be a scale that represents dissimilarities between two classes because it is the same as the feeling of recognizing the difference between two classes by the human eyes and brain.

(Conclusion)

Thus, by using this technique of the “quantification of a Mandala pattern in a distance-accumulation image (the measurement of dissimilarities (strength of the Mandala pattern) by segmenting the distance-accumulation image) for the distance-accumulation image ϕϕ obtained by the distance matrix imaging method, the strength of a difference (dissimilarity) between image pixels in position, size, and symmetry (dissimilarity) could be quantified simultaneously. Like a Mandala pattern, for example, it could also be confirmed that the difference was elliptical and symmetrical, and spread out radially from the center point.

### 7. Comparisons with Related Technology

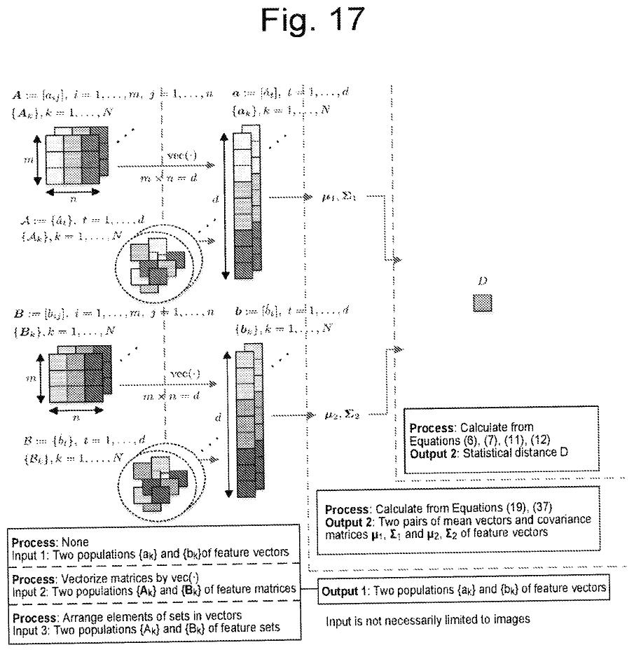

An explanatory diagram on related technology 1 concerning the statistical distance is illustrated in FIG. 17.

The embodiments of the present invention are compared with the related technology 1 below. In this related technology 1, the processing unit 11 finds two pairs of mean vectors and covariance matrices μμ1, ΣΣ1 and μ2, ΣΣ2 of the input feature vectors by Equations (19) and (37) for the two populations {aak} and {bbk} of the feature vectors. Next, the processing unit 11 uses the two pairs of mean vectors and covariance matrices μμ1, ΣΣ1 and μμ2, ΣΣ2 to calculate a statistical distance D from Equations (6), (7), (11) or (12).

By contrast, for example, the embodiments of the present invention differ from the related technology 1 in that the statistical distance matrix DD as a matrix that can represent an image or the like is calculated instead of the scalar statistical distance D like in the related technology 1.

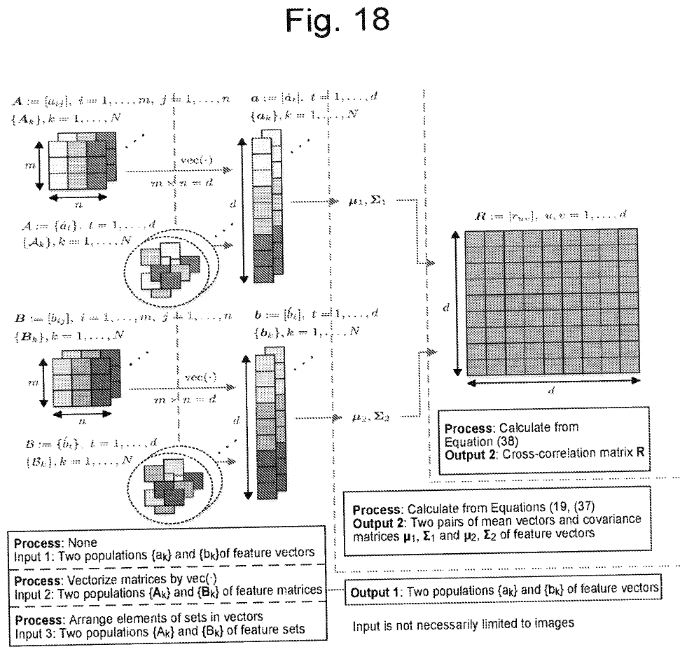

An explanatory diagram on related technology 2 concerning the cross-correlation matrix is illustrated in FIG. 18.

The embodiments of the present invention are compared with the related technology 2 below. In this related technology 2, the processing unit 11 finds two pairs of mean vectors and covariance matrices μμ1, ΣΣ1 and μμ2, ΣΣ2 of the input feature vectors by Equations (19) and (37) for the two populations {aak} and {bbk} of the input feature vectors. Next, the processing unit 11 uses the two pairs of mean vectors and covariance matrices μμ1, ΣΣ1 and μμ2, ΣΣ2 to calculate a cross-correlation matrix RR from Equation (38).

By contrast, for example, the embodiments of the present invention differ from the related technology 2 in that the statistical distance matrix DD as a matrix that can represent an image or the like is calculated instead of the cross-correlation matrix RR like in the related technology 2.

### 8. Examination

First, the reason why the statistical distance matrices DDB and DDC are effective for measuring feature distances will be described. In DDB and DDC, there are quadratic terms related to the mean vectors μμ1 and μμ2, and the covariance matrices ΣΣ1 and ΣΣ2. Such quadratic terms also exist in DDM and DDKL. On the other hand, DDB and DDC contain only the logarithm of a covariance ratio and there is a term in which no mean vector is contained. In DDM, there is no term containing the covariance matrix, and in DDKL, there is a term containing the covariance ratio but not calculated logarithmically. When two mean vectors are equal or approximate to each other, the quadratic terms tend to be zero. In other words, when the two probability distributions largely overlap, the covariance ratio term plays a more important role than the quadratic term. This is considered to be the reason that DDB and DDC are effective.

Next, the reason why clustering is necessary will be described. Before clustering, the statistical distance matrix DD represents all of local distances between elements of random vectors X. Since many local distances are very close to zero, DD is prone to be sparse. On the other hand, in graph theory, DD is defined as elements whose vertices are X, and can be mapped to a directed graph, whose edges are assigned to local distances δ. However, in many applications, when the edges with small values are processed in such a sparse graph, it is assumed that the calculations become complicated. Therefore, for example, there is a need to reduce the number of unimportant edges in the graph and to rearrange the vertices hierarchically according to the important edges with reassigned values. A tree structure obtained by such deformation will be able to greatly accelerate the data access speed and save computer memory space.

Finally, the relation between the statistical distance matrix and a weight matrix of a capsule neural network (CapsNet), which is a novel and useful model of neural networks proposed in [5] is examined. The statistical distance matrices proposed in the present invention and/or the embodiments have viewpoint invariance. Therefore, the statistical distance matrices can be used as they are to distinguish a target because they do not affect the distinction of the target no matter how much the pose of the target has changed in the image. However, compared to the weight matrix of CapsNet, the statistical distance matrices were more intuitive based on the distance-accumulation images and more specifiable by using the hierarchical clustering method. Therefore, the statistical distance matrices and the clustering results thereof, represented as “Information Mandalas,” can be considered to be superior to the weight matrix.

(Conclusion)

As described above, through the comparative experiments of images, it was first clarified that the statistical distance matrix like DDC directly calculated by setting the values of pixels as feature elements could be more effective in distinguishing a target than other distances. Next, the distance-accumulation image as the newly proposed representation method of the statistical distance matrix indicated that high-valued pixels were concentrated in the middle of the image. Further, when the statistical distance matrix was hierarchically clustered, it was found that all or most of pixel clusters basically surrounded the center of the image and were arranged radially from inside to outside according to the distance value. Since these patterns are very similar to Mandalas, the statistical distance matrix with the clustering results thereof is called “Information Mandala.” The “Information Mandala” is a new form of entropy, which is considered an important means to understand convolutional neural networks.

### 9. Clustering of Distance Matrix

Ordinary hierarchical clustering [10] is introduced to speed up the distance matrix processing to cluster the elements of a random vector based on the statistical distance matrix.

It is considered that input to the hierarchical clustering algorithm is the statistical distance matrix DD, that is, a cluster label set SS and a distance function δ. The cluster label set S:={1, . . . , d} is given by the number d of dimensions of the random vector X (feature vector). Further, cluster labels included in S are attached to elements of the feature vector in order. In the distance matrix DD, mapping of the distance function δ obtained by treating, as variables, subscripts u, v E S that represent the position of the element δuv and functionalizing δuv is set as δ: S×S→R. The value of δuv is assigned to δ(u, v). Here, δ(u, u) is set to 0. When there are d elements in the set S, (d2) pairwise distances exist.

The output of the hierarchical clustering algorithm is defined by a tree diagram L and a cluster label set (element label set). The tree diagram can be regarded as a data structure, and represented as a mathematical graph. In the present invention and/or the embodiments, the tree diagram is used. When a cluster label set S0 with cardinality d=|S0|, that is, S0:={1, . . . , d}, is given, the tree diagram L consists of a list of ordered tuples <ui, vi, δ(ui, vi)>, i=0, . . . , d−2 corresponding to cluster labels ni. Here, ui, vi∈Si. The cluster label set S0 is an initial cluster label set, and a cluster label set Si+1 in step i+1 is defined recursively as (Si\{ui, vi}∪ni. In each step, a new cluster labeled ni is formed by joining clusters labeled ui and vi at distance δ(ui, vi). Since the procedure contains d−1 steps, all of d initial clusters are contained in one cluster in the final state. Note that when the number of element clusters is set to j=d−i,j=1, . . . , d, clustering results related to j element clusters are contained in the cluster label set Sd-j.

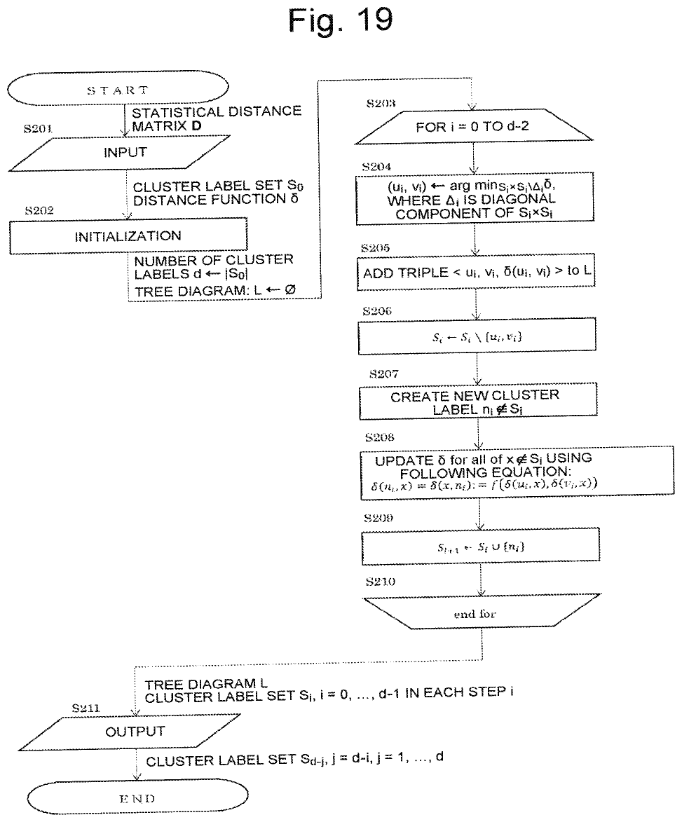

A flowchart of hierarchical clustering is illustrated in FIG. 19.

The proposed hierarchical clustering algorithm is illustrated below.

The processing unit 11 can realize the hierarchical clustering by executing each step process of the algorithm along the flowchart as below.

(Step S201) Input

The processing unit 11 inputs the statistical distance matrix DD.
Namely,
Cluster label set: S0
Distance function: δ

(Step S202)

The processing unit 11 performs initialization.
Number of cluster labels: d←|S0|
Tree diagram: L←(empty tree diagram)

(Step S203)

The processing unit 11 repeats processes from step S203 to step S210 below for i=0 to d−2.

(Step S204)

The processing unit 11 executes (ui, vi)←arg minSi×Si\Δiδ.

Δi is a diagonal component of Si×Si.

(Here, “arg min” represents that the value of an argument (u_i, v_i) to minimize an objective function δ is given in a section S_i×S_i\Δ_i. Further, the section S_i×S_i\Δ_i represents S_i×S_i except for Δ_i.)

(Step S205)

The processing unit 11 adds a triple (triplet) <ui, vi, δ(ui, vi)> to L.

(Step S206)

The processing unit 11 executes Si←Si\{ui, vi}.

(This formula expresses that the set Si except for {ui, vi} is substituted into Si.)

(Step S207)

The processing unit 11 creates a new cluster label ni (not belonging to Si).

(Step S208)

The processing unit 11 uses the following equation to update δ for all of x∈Si using Equation below.

δ(ni,x)=δ(x,ni):=f(ui,x),δ(vi,x).

(Step S209)

The processing unit 11 executes Si←Si∪{ni}.

(Step S210)

The processing unit 11 repeats the above processes from step S203 to step S210 for i=0 to d−2 (end for).

(Step S211)

The processing unit 11 displays the following results on the display unit 14, and/or outputs the results through the output unit 13 or the I/F 16.

Tree diagram: L

Cluster label set: Si, i=0, . . . , d−1 in each step i.

Namely,

Cluster label set: Sd-j, j=d-i, i=1, . . . , d that represents each of j element clusters.

Here, the aggregation formula for updating δ is defined as in Equation below.

f(δ(ui,x),δ(vi,x)):=max(δ(ui,x),δ(vi,x)) (18)

When an appropriate cut-off threshold is specified, this algorithm can provide stable clustering results for elements of the random vector (feature vector).

### 10. Appendix: Derivation of Bhattacharya Distance DB (Equation (7))

The d-dimensional random vectors X1 and X2 follow two normal distributions N(μμ1, ΣΣ1) and N(μμ2, ΣΣ2), respectively, and corresponding probability density functions p(xx) and q(xx) are defined as in Equation (21). Further, the product of these square roots is expressed in Equation (22).

$$[ Math . 15 ]$$

$$\text{?} \qquad ( 21 )$$

$$\text{?} \begin{matrix} & ( 22 )\end{matrix}$$

$$\text{?} \text{indicates text missing or illegible when filed}$$

By integrating Equation (22) in the real coordinate space Rd with respect to the d-dimensional variable vector xx, the following equation is obtained.

$$\begin{matrix}[ Math . 16 ] & \\ \text{?} & ( 23 )\end{matrix}$$

$$\text{?} \qquad ( 24 )$$

$$\text{?} \qquad ( 25 )$$

$$\text{?} \text{indicates text missing or illegible when filed}$$

In order to simplify the factor expressions (23), (24), and (25) together in this equation, Equation (26) is first prepared. Equation (27) and Equation (28) were used to derive Equation (26).

$$\begin{matrix}[ Math . 17 ] & \\ \text{?} & ( 26 )\end{matrix}$$

$$\text{?} \qquad ( 27 )$$

$$\text{?} \qquad ( 28 )$$

$$\text{?} \text{indicates text missing or illegible when filed}$$

Further, note that Equation (27) holds by Equation (29). Here, AA, BB, and CC are all positive definite matrices. Further, ΣΣ is defied by Equation (30).

$$\begin{matrix}[ Math . 18 ] & \\ \text{?} & ( 29 )\end{matrix}$$

$$\text{?} \qquad ( 30 )$$

$$\text{?} \text{indicates text missing or illegible when filed}$$

Next, Equation (25) is transformed into Equation (31). Here, the d-dimensional variable vector yy is defined by Equation (32).

$$\begin{matrix}[ Math . 19 ] & \\ \text{?} & ( 31 )\end{matrix}$$

$$\text{?} \qquad ( 32 )$$

$$\text{?} \text{indicates text missing or illegible when filed}$$

Then, Equation (24) and the first factor of Equation (31) are multiplied to obtain Equation (33).

$$\begin{matrix}[ Math . 20 ] & \\ \text{?} & ( 33 )\end{matrix}$$

$$\text{?} \text{indicates text missing or illegible when filed}$$

On the other hand, the second factor of Equation (31) can be transformed as in Equation (34) by a change-of-variable method. Further, Equation (23) is multiplied by Equation (34) to obtain Equation (35).

$$\begin{matrix}[ Math . 21 ] & \\ \text{?} & ( 34 )\end{matrix}$$

$$\text{?}$$

$$\text{?} \text{indicates text missing or illegible when filed}$$

Thus, as in Equation (36), a negative logarithm of the multiplication of Equation (33) and Equation (35) is set as the Bhattacharya distance DB.

$$\begin{matrix}[ Math . 22 ] & \\ \text{?} & ( 36 )\end{matrix}$$

$$\text{?} \text{indicates text missing or illegible when filed}$$

### 11. REFERENCES

Note that letters in the German alphabet such as umlaut letters are replaced with letters in the English alphabet due to the restrictions on letters and symbols capable of being used in electronic application software or for convenience.
[1] A. Bhattacharyya. On a measure of divergence between two statistical populations defined by their probability distributions. Bulletin of the Calcutta Mathematical Society, 35: 99-109,1943.
[2] H. Chernoff. A measure of asymptotic efficiency for tests of a hypothesis based on the sums of observations. Annals of Mathematical Statistics, 23: 409-507,1952.
[3] Frank Harary, Robert Z. Norman, and Dorwin Cartwright. Structural models: an introduction to the theory of directed graphs. Wiley, New York, 1965.
[4] E. Hellinger. Neue begrundung der theorie quadratischer formen von unendlichvielen veranderlichen. Journal fur die reine and angewandte Mathematik, 1909(136): 210{271,1909.
[5] G. E Hinton, S. Sabour, and N. Frosst. Matrix capsules with EM routing. In International Conference on Learning Representations, 2018.
WO2019083553A1, US20200285934A1
[6] A. Krizhevsky, V. Nair, and G. E Hinton. CIFAR-10 (Canadian Institute for Advanced Research).
Alex Krizhevsky, Vinod Nair, and Geoffrey Hinton. ‘Learning multiple layers of features from tiny images’, Alex Krizhevsky, 2009. “The CIFAR-10 dataset,” Apr. 8, 2009.
URL: https://www.cs.toronto.edu/-kriz/cifar.html
[7] S. Kullback and R. A. Leibler. On information and sufficiency. The Annals of Mathematical Statistics, 22(1): 79-86, 1951.
[8] J. B. MacQueen. Some methods for classification and analysis of multivariate observations. In L. M. Le Cam and J. Neyman, editors, Proc. of the fifth Berkeley Symposium on Mathematical Statistics and Probability, volume 1, pages 281{297,1967.
[9] P. C. Mahalanobis. On the generalized distance in statistics. In Proceedings of the National Institute of Sciences (Calcutta), 2: 49-55, 1936.
[10] D. Mullner. Modern hierarchical, agglomerative clustering algorithms. arXiv e-prints, page arXiv: 1109.2378, September 2011.
[11] A. Fitzgibbon, M. Pilu, R. B. Fisher, “Direct least square fitting of ellipse,” IEEE Trans. Pattern Analysis and Machine Intelligence, vol. 21, no. 5, pp. 476-480, 1999.
[12] https://mathworld.wolfram.com/Ellipse.html

### REFERENCE SIGNS LIST

100 PC
11 processing unit
12 input unit
13 output unit
14 display unit
15 storage unit
16 interface unit (I/F)
151 input data file
152 statistical distance matrix file
153 distance matrix file
154 cluster matrix file
155 output file

1. A statistical distance matrix calculation method comprising:
causing a processing unit to input, from an input unit or any other device or a storage unit, first vector data aa and second vector data bb as targets for comparison, or causing the processing unit to input, from the input unit or any other device or the storage unit, a first matrix or image or aggregate data AA and a second matrix or image or aggregate data BB as targets for comparison, and vectorize the first matrix or image or aggregate data AA and the second matrix or image or aggregate data BB into the first vector data aa and the second vector data bb;
causing the processing unit to calculate, from the first vector data aa and the second vector data bb, a first mean vector μμ1 and a second mean vector μμ2, and a first covariance matrix ΣΣ1 and a second covariance matrix ΣΣ2, respectively;
causing the processing unit to find a statistical distance matrix DD (here, D=trDD) as a de-trace form of a statistical distance D defined by the first mean vector μμ1, the second mean vector μμ2, the first covariance matrix ΣΣ1, and the second covariance matrix ΣΣ2; and
causing the processing unit to store the statistical distance matrix DD in the storage unit, or display the statistical distance matrix DD on a display unit, or output the statistical distance matrix DD through an output unit.

2. The statistical distance matrix calculation method according to claim 1,
wherein the statistical distance and the statistical distance matrix are any one or more of the following:
the statistical distance is Bhattacharya distance DB (=trDDB) and the statistical distance matrix is Bhattacharya distance matrix DDB,
the statistical distance is Chernoff Distance DC(=trDDC) and the statistical distance matrix is Chernoff Distance matrix DDC,
the statistical distance is Kullback-Leibler Divergence distance DKL (=trDDKL) and the statistical distance matrix is Kullback-Leibler Divergence distance matrix DDKL,
the statistical distance is Mahalanobis Distance DM (=trDDM) and the statistical distance matrix is Mahalanobis Distance matrix DDM, and
the statistical distance is a statistical distance D (=trDD) capable of being represented in a trace form and the statistical distance matrix is DD.

3. A statistical distance matrix visualization method comprising:
causing a processing unit to input, from an input unit or any other device or a storage unit, first vector data aa and second vector data bb as targets for comparison, or causing the processing unit to input, from the input unit or any other device or the storage unit, a first matrix or image or aggregate data AA and a second matrix or image or aggregate data BB as targets for comparison, and vectorize the first matrix or image or aggregate data AA and the second matrix or image or aggregate data BB into the first vector data aa and the second vector data bb;
causing the processing unit to calculate, from the first vector data aa and the second vector data bb, a first mean vector μμ1 and a second mean vector μμ2, and a first covariance matrix ΣΣ1 and a second covariance matrix ΣΣ2, respectively;
causing the processing unit to find a statistical distance matrix DD (here, D=trDD) as a de-trace form of a statistical distance D defined by the first mean vector μμ1, the second mean vector μμ2, the first covariance matrix ΣΣ1, and the second covariance matrix ΣΣ2;
causing the processing unit to accumulate row and column distance elements including diagonal elements for respective diagonal elements of the statistical distance matrix DD to find a distance accumulation vector φφ;
causing the processing unit to matrix the distance accumulation vector φφ into a distance accumulation matrix ϕϕ; and
causing the processing unit to store the distance accumulation matrix ϕϕ or an image by the distance accumulation matrix ϕϕ in the storage unit, or display the distance accumulation matrix ϕϕ or the image by the distance accumulation matrix ϕϕ on a display unit, or output the distance accumulation matrix ϕϕ or the image by the distance accumulation matrix ϕϕ through an output unit.

4. The statistical distance matrix visualization method according to claim 3 further comprising:
causing the processing unit to execute clustering processing on the statistical distance matrix DD to find a cluster label vector or set, or an element label set in which a cluster label for each row number or each column number, or a cluster label for an element ID corresponding to each row number or each column number is set as an element; and
causing the processing unit to further attach a cluster label to each element in the row and column of the distance accumulation matrix ϕϕ corresponding to the row or column after the cluster label vector or set, or the label set is matrixed.

5. The statistical distance matrix visualization method according to claim 3 or 4, wherein
the processing unit determines similarities between the first vector data aa and the second vector data bb from a pattern of the distance accumulation matrix ϕϕ, and
the processing unit stores data representing the similarities in the storage unit, or displays the data on the display unit, or outputs the data through the output unit.

6. A statistical distance matrix visualization method comprising:
causing a processing unit to input, from an input unit or any other device or a storage unit, first vector data aa and second vector data bb as targets for comparison, or causing the processing unit to input, from the input unit or any other device or the storage unit, a first matrix or image or aggregate data AA and a second matrix or image or aggregate data BB as targets for comparison, and vectorize the first matrix or image or aggregate data AA and the second matrix or image or aggregate data BB into the first vector data aa and the second vector data bb;
causing the processing unit to calculate, from the first vector data aa and the second vector data bb, a first mean vector μμ1 and a second mean vector μμ2, and a first covariance matrix ΣΣ1 and a second covariance matrix ΣΣ2, respectively;
causing the processing unit to find a statistical distance matrix DD (here, D=trDD) as a de-trace form of a statistical distance D defined by the first mean vector μμ1, the second mean vector μμ2, the first covariance matrix ΣΣ1, and the second covariance matrix ΣΣ2;
causing the processing unit to execute clustering processing on the statistical distance matrix DD in order to find a cluster label vector or set in which a cluster label for a number or an ID corresponding to each row or a number or an ID corresponding to each column is set as an element;
causing the processing unit to matrix the cluster label vector or set into a cluster label matrix; and
causing the processing unit to store the cluster label matrix or an image by the cluster label matrix in the storage unit, or display the cluster label matrix or the image by the cluster label matrix on a display unit, or output the cluster label matrix or the image by the cluster label matrix through an output unit.

7. The statistical distance matrix visualization method according to claim 6, wherein
the processing unit determines similarities between the first vector data aa and the second vector data bb from a pattern of the cluster matrix, and
the processing unit stores data representing the similarities in the storage unit, or displays the data on the display unit, or outputs the data through the output unit.

8. The statistical distance matrix visualization method according to any one of claims 3 to 7, wherein the statistical distance and the statistical distance matrix are any one or more of the following:
the statistical distance is a Bhattacharya distance DB (=trDDB), and the statistical distance matrix is a Bhattacharya distance matrix DDB;
the statistical distance is a Chernoff Distance DC(=trDDC), and the statistical distance matrix is a Chernoff Distance matrix DDC;
the statistical distance is a Kullback-Leibler Divergence distance DKL (=trDDKL), and the statistical distance matrix is a Kullback-Leibler Divergence distance matrix DDKL;
the statistical distance is a Mahalanobis Distance DM (=trDDM), and the statistical distance matrix is a Mahalanobis Distance matrix DDM; and
the statistical distance is a statistical distance D (=trDD) capable of being represented in a trace form, and the statistical distance matrix is DD.

9. The statistical distance matrix visualization method according to claim 5 or 7, wherein the processing unit performs segmentation on each element of the distance accumulation matrix ϕϕ using predetermined two or more thresholds, cuts out plural types of element areas, and determines the similarities by an area ratio ρ based on predetermined respective element areas.

10. The statistical distance matrix visualization method according to claim 5 or 7, wherein the processing unit determines the similarities by a Mandala pattern as a Mandala-shaped image in which the pattern is a circular, elliptical, square, or rectangular shape, and radiates from a center point.

11. A statistical distance matrix visualization device comprising a processing unit, wherein
the processing unit inputs, from an input unit or any other device or a storage unit, first vector data aa and second vector data bb as targets for comparison, or the processing unit inputs, from the input unit or any other device or the storage unit, a first matrix or image or aggregate data AA and a second matrix or image or aggregate data BB as targets for comparison, and vectorizes the first matrix or image or aggregate data AA and the second matrix or image or aggregate data BB into the first vector data aa and the second vector data bb,
the processing unit calculates, from the first vector data aa and the second vector data bb, a first mean vector μμ1 and a second mean vector μμ2, and a first covariance matrix ΣΣ1 and a second covariance matrix ΣΣ2, respectively,
the processing unit finds a statistical distance matrix DD (here, D=trDD) as a de-trace form of a statistical distance D defined by the first mean vector μμ1, the second mean vector μμ2, the first covariance matrix ΣΣ1, and the second covariance matrix ΣΣ2,
the processing unit accumulates row and column distance elements including diagonal elements for respective diagonal elements of the statistical distance matrix DD to find a distance accumulation vector φφ,
the processing unit matrixes the distance accumulation vector φφ into a distance accumulation matrix ϕϕ, and
the processing unit stores the distance accumulation matrix ϕϕ or an image by the distance accumulation matrix ϕϕ in the storage unit, or displays the distance accumulation matrix ϕϕ or the image by the distance accumulation matrix ϕϕ on a display unit, or outputs the distance accumulation matrix ϕϕ or the image by the distance accumulation matrix ϕϕ through an output unit.

12. A statistical distance matrix visualization program causing a computer to execute steps of:
causing a processing unit to input, from an input unit or any other device or a storage unit, first vector data aa and second vector data bb as targets for comparison, or causing the processing unit to input, from the input unit or any other device or the storage unit, a first matrix or image or aggregate data AA and a second matrix or image or aggregate data BB as targets for comparison, and vectorize the first matrix or image or aggregate data AA and the second matrix or image or aggregate data BB into the first vector data aa and the second vector data bb;
causing the processing unit to calculate, from the first vector data aa and the second vector data bb, a first mean vector μμ1 and a second mean vector μμ2, and a first covariance matrix ΣΣ1 and a second covariance matrix ΣΣ2, respectively;
causing the processing unit to find a statistical distance matrix DD (here, D=trDD) as a de-trace form of a statistical distance D defined by the first mean vector μμ1, the second mean vector μμ2, the first covariance matrix ΣΣ1, and the second covariance matrix ΣΣ2;
causing the processing unit to accumulate row and column distance elements including diagonal elements for respective diagonal elements of the statistical distance matrix DD to find a distance accumulation vector φφ;
causing the processing unit to matrix the distance accumulation vector φφ into a distance accumulation matrix ϕϕ; and
causing the processing unit to store the distance accumulation matrix ϕϕ or an image by the distance accumulation matrix ϕϕ in the storage unit, or display the distance accumulation matrix ϕϕ or the image by the distance accumulation matrix ϕϕ on a display unit, or output the distance accumulation matrix ϕϕ or the image by the distance accumulation matrix ϕϕ through an output unit.
